(19) United States
(12) Patent Application Publication
(10) Pub. No.: US 2026/0098119 A1
(43) Pub. Date: Apr. 9, 2026

(54) FLAME RETARDANT COMPOSITIONS, COMPOUNDS, AND METHODS OF MAKING

(71) Applicant: H.B. Fuller Company, St. Paul, MN (US)

(72) Inventor: Albert M. Giorgini, Lino Lakes, MN (US)

(21) Appl. No.: 19/112,740

(22) PCT Filed: Sep. 25, 2023
(86) PCT No.: PCT/US2023/075021

§ 371 Date: Mar. 18, 2025

Related U.S. Application Data
(60) Provisional application No. 63/377,139, filed on Sep. 26, 2022.

(51) Int. Cl. C08G 18/48; C08G 18/18; C08G 18/32; C08G 18/76; C08K 3/04; H01M 50/143

(52) U.S. Cl. CPC C08G 18/4829; C08G 18/18; C08G 18/3215; C08G 18/7657; C08K 3/042; H01M 50/143; C08G 2110/0083

(57) ABSTRACT

A composition configured to cure to form a foam compound exhibiting at least a V2 level flame resistance as measured by the UL 94 Test for Flammability of Plastics, when measured with a sample of the foam compound having a thickness of no greater than one millimeter.

### CROSS REFERENCE TO RELATED APPLICATIONS

This application claims the benefit of U.S. Provisional Application No. 63/377,139, filed Sep. 26, 2022, which is incorporated herein.

### FIELD

The present disclosure relates to compositions and compounds having flame retardant properties. The present disclosure relates to compositions and compounds containing one or more flame retardants and which are suitable for potting electric cells in battery modules.

### BACKGROUND

In general, potting is the process of partially or completely filling a space defined within an enclosure with a material for the purpose of maintaining objects within the enclosure in spatial relation to one another and to the enclosure. Potting may be used to provide resistance to shock and vibration. Certain compositions used for potting may be designed for creating a seal against moisture, solvents, and corrosive agents

Materials used to form potting compounds vary in hardness from very soft to hard and rigid, and are designed to withstand various environments. Compounds for use in potting electric cells may be designed to provide mechanical stability and shock tolerance, for example for battery modules for a vehicle.

A compound that provides mechanical stability to an object being contained while adding minimal weight to the object being contained is desired. A compound for use in a battery module and that provides flame retardancy is desired. A composition for forming a flame retardant potting compound for use in a battery module is desired.

### SUMMARY

Disclosed herein is a composition including a first component comprising an isocyanate reactive compound and a blowing agent, and a second component comprising an isocyanate compound. At least one of the first and second component includes at least 15% by weight, based on the total weight of the composition, a first flame retardant component. The composition is configured to cure to form a foam compound exhibiting at least a V2 level flame resistance as measured by the UL 94 Test for Flammability of Plastics, when measured with a sample of the foam compound having a thickness of no greater than 1.6 millimeters. In some aspects, the composition is configured to cure to form a foam compound exhibiting at least a V2 level flame resistance as measured by the UL 94 Test for Flammability of Plastics, when measured with a sample of the foam compound having a thickness of no greater than one millimeter.

In some aspects, the composition is configured to cure to form a foam compound exhibiting at least a V1 level flame resistance as measured by the UL 94 Test for Flammability of Plastics, when measured with a sample of the foam compound having a thickness of no greater than one millimeter. In some aspects, the composition is configured to cure to form a foam compound exhibiting at least a V0 level flame resistance as measured by the UL 94 Test for Flammability of Plastics, when measured with a sample of the foam compound having a thickness of no greater than one millimeter.

In some aspects, the composition is configured to cure to form a foam compound exhibiting a compressive strength of at least 20 psi, when measured with the Foam Integrity Test with a sample of the foam compound having a thickness of no greater than one millimeter. In some aspects, the composition is configured to cure to form a foam compound exhibiting a compressive strength of of at least 30 psi, when measured with the Foam Integrity Test with a sample of the foam compound having a thickness of no greater than one millimeter. In some aspects, the composition is configured to cure to form a foam compound exhibiting a compressive strength of of at least 20 psi, when measured with the Foam Integrity Test with a sample of the foam compound having a thickness of no greater than 1.6 mm. In some aspects, the composition is configured to cure to form a foam compound exhibiting a compressive strength of of at least 20 psi, when measured with the Foam Integrity Test with a sample of the foam compound having a thickness of no greater than two mm. In some aspects, the composition is configured to cure to form a foam compound exhibiting a compressive strength of of at least 20 psi, when measured with the Foam Integrity Test with a sample of the foam compound having a thickness of no greater than three mm.

In some aspects, the composition is configured to cure to form a foam compound exhibiting at least a V0 level flame resistance as measured by the UL 94 Test for Flammability of Plastics when tested with a sample of the foam compound having a thickness of no greater than 6.5 mm. In some aspects, the composition is configured to cure to form a foam compound exhibiting at least a V0 level flame resistance as measured by the UL 94 Test for Flammability of Plastics when tested with a sample of the foam compound having a thickness of no greater than two mm.

In some aspects, the first component has a viscosity from greater than one to less than 5500 cP, and wherein the second component has a viscosity from greater than one to less than 1000 cP, all at a temperature from 25° C. to 35° C. In some aspects, the composition further comprises a second flame retardant component. In some aspects, the composition further comprises a second flame retardant component comprising a non-halogenated expandable graphite. In some aspects, the composition further comprises a second flame retardant component in both the first component and the second component. In some aspects, the composition further comprises at least one % by weight a second flame retardant component based on the total weight of the composition.

In some aspects, the composition further comprises from at least one % to 14% by weight a second flame retardant component, based on the total weight of the composition. In some aspects, the first component, second component, first flame retardant component and second flame retardant component are configured to be combined to form a mixture having a viscosity no greater than 2000 cP within one minute after forming, when measured at an ambient temperature of about 25° C., with a Brookfield RVF viscometer at 50 rpm using an RV-3 spindle.

In some aspects, the composition comprises at least 20% by weight the first flame retardant component based on the total weight of the composition. In some aspects, the composition comprises greater than 25% by weight the first flame retardant component based on the total weight of the composition. In some aspects, the composition comprises at least 30% by weight the first flame retardant component based on the total weight of the composition.

In some aspects, the first flame retardant component includes a phosphate ester. In some aspects, the first component includes an isocyanate reactive compound having a functionality of three or more. In some aspects, the isocyanate reactive compound is a polyol. In some aspects, the isocyanate reactive compound includes at least one polyether polyol. In some aspects, the isocyanate compound includes MDI. In some aspects, the isocyanate compound includes polymeric MDI.

In some aspects, the first flame retardant component has a viscosity of no greater than 300 cP at a temperature from 25° C. to 35° C. In some aspects, the first flame retardant component exhibits a viscosity from about 10 cP to about 2000 cP at a temperature from 25° C. to 35° C. In some aspects, the composition is configured to cure to form a foam compound having a density of less than 0.60 g/cm³.

In some aspects, the first component includes from 20 wt. % to 40 wt % polyol, from 20 wt. % to 50 wt. % a phosphate ester flame retardant component, and from 0.4 wt. % to 2.0 wt. % a blowing agent, all based on the total weight of the first component; and the second component includes from 10 wt % to 90 wt. % MDI and from 10 wt. % to 90 wt. % a phosphate ester flame retardant component, all based on the total weight of the second component, and at least the one of the first component and second component includes from one wt. % to 14 wt. % a second flame retardant component based on the total weight of the composition.

In some aspects, at least one of the following (a) and (b) are exhibited when measured with a Brookfield RVF viscometer at a spindle speed of 50 rpm at a temperature from 25° C. to 35° C.: (a) the first component has a viscosity from greater than one to less than 5500 cP, (b) the second component has a viscosity from greater than one to less than 1000 cP.

Disclosed herein is a composition including a first component comprising an isocyanate reactive compound and a blowing agent; a second component comprising an isocyanate compound; and at least one of the first and second component includes at least 15% by weight, based on the total weight of the composition, a first flame retardant component that is liquid at a temperature from 25° C. to 35° C. At least one of the first and second component includes at least one % by weight based on the total weight of the composition, a second flame retardant component comprising an expandable graphite. The first component, second component, first flame retardant and second flame retardant are configured to be combined to form a mixture having a viscosity no greater than 2000 cP within one minute after forming, when measured at an ambient temperature of about 25° C., with a Brookfield RV viscometer at 50 rpm using an RV-3 spindle.

In some aspects, the composition is configured to cure to form a foam compound exhibiting at least a V2 level flame resistance as measured by the UL 94 Test for Flammability of Plastics when tested with a sample of the foam compound having a thickness of no greater than one millimeter. In some aspects, the composition is configured to cure to form a foam compound exhibiting at least a V1 level flame resistance as measured by the UL 94 Test for Flammability of Plastics when tested with a sample of the foam compound having a thickness of no greater than one millimeter.

In some aspects, the composition is configured to cure to form a foam compound exhibiting at least a V0 level flame resistance as measured by the UL 94 Test for Flammability of Plastics when tested with a sample of the foam compound having a thickness of no greater than one millimeter. In some aspects, the composition is configured to cure to form a foam compound exhibiting at least a V0 level flame resistance as measured by the UL 94 Test for Flammability of Plastics when tested with a sample of the foam compound having a thickness of no greater than 6.5 mm. In some aspects, the composition is configured to cure to form a foam compound exhibiting at least a V0 level flame resistance as measured by the UL 94 Test for Flammability of Plastics when tested with a sample of the foam compound having a thickness of no greater than two mm.

In some aspects, the composition is configured to cure to form a foam compound exhibiting a compressive strength of of at least 20 psi, when measured with the Foam Integrity Test with a sample of the foam compound having a thickness of no greater than one millimeter. In some aspects, the composition is configured to cure to form a foam compound exhibiting a compressive strength of of at least 20 psi, when measured with the Foam Integrity Test with a sample of the foam compound having a thickness of no greater than 1.6 mm. In some aspects, the composition is configured to cure to form a foam compound exhibiting a compressive strength of of at least 20 psi, when measured with the Foam Integrity Test with a sample of the foam compound having a thickness of no greater than two mm. In some aspects, the composition is configured to cure to form a foam compound exhibiting a compressive strength of of at least 20 psi, when measured with the Foam Integrity Test with a sample of the foam compound having a thickness of no greater than three mm.

In some aspects, the first component has a viscosity from greater than one to less than 5500 cP, and wherein the second component has a viscosity from greater than one to less than 1000 cP, all at a temperature from 25° C. to 35° C. In some aspects, the first component, second component, first flame retardant and second flame retardant are configured to be combined to form a mixture having a viscosity no greater than 2000 cP within one minute after forming, when measured at an ambient temperature of about 25° C., with a Brookfield RV viscometer at 50 rpm using an RV-3 spindle. In some aspects, the first and second flame retardant component are present in both the first component and the second component.

In some aspects, the second flame retardant is a non-halogenated expandable graphite. In some aspects, the first flame retardant component includes a phosphate ester. In some aspects, the composition comprises at least 20% by weight the first flame retardant component based on the total weight of the composition. In some aspects, the composition comprises greater than 25% by weight the first flame retardant component based on the total weight of the composition. In some aspects, the composition comprises at least 30% by weight the first flame retardant component based on the total weight of the composition.

In some aspects, the first component includes an isocyanate reactive compound having a functionality of three or more. In some aspects, the isocyanate reactive compound is a polyol. In some aspects, the isocyanate reactive compound includes at least one polyether polyol. In some aspects, the isocyanate compound includes MDI. In some aspects, the isocyanate compound includes polymeric MDI.

In some aspects, the first component includes from 20 wt. % to 40 wt. % polyol, from 20 wt. % to 50 wt. % a phosphate ester flame retardant; and from 0.4 wt. % to 2.0 wt. % a blowing agent, all based on the total weight of the first component; and the second component includes from 10 wt. % to 90 wt. % MDI; and from 10 wt. % to 90 wt. % a phosphate ester flame retardant; all based on the total weight of the second component, and at least the one of the first component and second component includes from one wt. % to 14 wt. % a second flame retardant based on the total weight of the composition.

In some aspects, the first flame retardant component has a viscosity of no greater than 300 cP at a temperature from 25° C. to 35° C. In some aspects, the first flame retardant component exhibits a viscosity from about 200 cP to about 2000 cP at a temperature from 25° C. to 35° C. In some aspects, the composition is configured to cure to form a foam compound having a density of less than 0.60 g/cm³.

In some aspects, at least one of the following (a) and (b) are exhibited when measured with a Brookfield RVF viscometer at a spindle speed of 50 rpm at a temperature from 25° C. to 35° C.: (a) the first component has a viscosity from greater than one to less than 5500 cP, (b) the second component has a viscosity from greater than one to less than 1000 cP.

Disclosed herein is a composition comprising a first component comprising an isocyanate reactive compound and a blowing agent: a second component comprising an isocyanate compound. At least one of the first and second component includes at least 15% by weight, based on the total weight of the composition, a first flame retardant component that is liquid at a temperature from 25° C. to 35° C.; and at least one of the first and second component includes at least one % by weight based on the total weight of the composition, a second flame retardant comprising an expandable graphite. At least one of the following (a) and (b) are exhibited when measured with a Brookfield RVF viscometer at a spindle speed of 50 rpm at a temperature from 25° C. to 35° C.: (a) the first component has a viscosity from greater than one to less than 5500 cP, (b) the second component has a viscosity from greater than one to less than 1000 cP.

In some aspects, the composition is configured to cure to form a foam compound exhibiting a compressive strength of of at least 20 psi, when measured with the Foam Integrity Test with a sample of the foam compound having a thickness of no greater than one millimeter. In some aspects, the composition is configured to cure to form a foam compound exhibiting a compressive strength of of at least 20 psi, when measured with the Foam Integrity Test with a sample of the foam compound having a thickness of no greater than 1.6 mm. In some aspects, the composition is configured to cure to form a foam compound exhibiting a compressive strength of of at least 20 psi, when measured with the Foam Integrity Test with a sample of the foam compound having a thickness of no greater than two mm. In some aspects, the composition is configured to cure to form a foam compound exhibiting a compressive strength of of at least 20 psi, when measured with the Foam Integrity Test with a sample of the foam compound having a thickness of no greater than three mm.

In some aspects, the composition is configured to cure to form a foam compound exhibiting at least a V2 level flame resistance as measured by the UL 94 Test for Flammability of Plastics when tested with a sample of the foam compound having a thickness of no greater than one millimeter. In some aspects, the composition is configured to cure to form a foam compound exhibiting at least a V1 level flame resistance as measured by the UL 94 Test for Flammability of Plastics when tested with a sample of the foam compound having a thickness of no greater than one millimeter.

In some aspects, the composition is configured to cure to form a foam compound exhibiting at least a V0 level flame resistance as measured by the UL 94 Test for Flammability of Plastics when tested with a sample of the foam compound having a thickness of no greater than one millimeter. In some aspects, the composition is configured to cure to form a foam compound exhibiting at least a V0 level flame resistance as measured by the UL 94 Test for Flammability of Plastics when tested with a sample of the foam compound having a thickness of no greater than 6.5 mm. In some aspects, the composition is configured to cure to form a foam compound exhibiting at least a V0 level flame resistance as measured by the UL 94 Test for Flammability of Plastics when tested with a sample of the foam compound having a thickness of no greater than two mm.

In some aspects, the second flame retardant comprises a non-halogenated expandable graphite. In some aspects, the second flame retardant is present in both the first component and the second component. In some aspects, the composition comprises from at least one % to 14% by weight the second flame retardant component, based on the total weight of the composition.

Disclosed herein is a composition a first component comprising an isocyanate reactive compound and a blowing agent, and a second component comprising an isocyanate compound. At least one of the first and second component includes at least 15% by weight, based on the total weight of the composition, a first flame retardant component. The composition is configured to cure to form a foam compound exhibiting a compressive strength of of at least 20 psi, when measured with the Foam Integrity Test with a sample of the foam compound having a thickness of no greater than one millimeter.

In some aspects, the composition is configured to cure to form a foam compound exhibiting at least a V1 level flame resistance as measured by the UL 94 Test for Flammability of Plastics when tested with a sample of the foam compound having a thickness of no greater than one millimeter. In some aspects, the composition is configured to cure to form a foam compound exhibiting a compressive strength of of at least 20 psi, when measured with the Foam Integrity Test with a sample of the foam compound having a thickness of no greater than 1.6 mm. In some aspects, the composition is configured to cure to form a foam compound exhibiting a compressive strength of of at least 20 psi, when measured with the Foam Integrity Test with a sample of the foam compound having a thickness of no greater than two mm. In some aspects, the composition is configured to cure to form a foam compound exhibiting a compressive strength of of at least 20 psi, when measured with the Foam Integrity Test with a sample of the foam compound having a thickness of no greater than three mm. In some aspects, the composition is configured to cure to form a foam compound exhibiting at least a V0 level flame resistance as measured by the UL 94 Test for Flammability of Plastics when tested with a sample of the foam compound having a thickness of no greater than one millimeter. In some aspects, the composition comprises a second flame retardant comprising a non-halogenated expandable graphite. In some aspects, the second flame retardant is present in both the first component and the second component. In some aspects, the composition comprises from at least one % to 14% by weight the second flame retardant component, based on the total weight of the composition.

Disclosed herein is a compound comprising a foam compound, the foam compound has a density of less than 0.60 g/cm³, and the foam compound exhibits at least a V2 level flame resistance as measured by the UL 94 Test for Flammability of Plastics when tested with a sample of the foam compound having a thickness of no greater than one millimeter. In some aspects, the foam compound exhibits at least a V1 level flame resistance as measured by the UL 94 Test for Flammability of Plastics when tested with a sample of the foam compound having a thickness of no greater than one millimeter. In some aspects, the foam compound exhibits at least a V0 level flame resistance as measured by the UL 94 Test for Flammability of Plastics when tested with a sample of the foam compound having a thickness of no greater than one millimeter.

In some aspects, the compound exhibits a compressive strength of of at least 20 psi, when measured with the Foam Integrity Test with a sample of the foam compound having a thickness of no greater than one millimeter. In some aspects, the compound exhibits a compressive strength of of at least 20 psi, when measured with the Foam Integrity Test with a sample of the foam compound having a thickness of no greater than two millimeters. In some aspects, the compound exhibits a compressive strength of of at least 20 psi, when measured with the Foam Integrity Test with a sample of the foam compound having a thickness of no greater than three millimeters.

In some aspects, the foam compound is at least one of a polyurethane foam compound, a silicone foam compound, and an epoxy-based foam compound.

In some aspects, the compound exhibits at least a V2 level flame resistance as measured by the UL 94 Test for Flammability of Plastics when tested with a sample of the compound having a thickness of no greater than one mm. In some aspects, the compound exhibits at least a V1 level flame resistance as measured by the UL 94 Test for Flammability of Plastics when tested with a sample of the compound having a thickness of no greater than one mm. In some aspects, the compound exhibits at least a V0 level flame resistance as measured by the UL 94 Test for Flammability of Plastics when tested with a sample of the compound having a thickness of no greater than one mm.

In some aspects, the compound exhibits at least a V2 level flame resistance as measured by the UL. 94 Test for Flammability of Plastics when tested with a sample of the compound having a thickness of no greater than 1.6 mm. In some aspects, the compound exhibits at least a V1 level flame resistance as measured by the UL 94 Test for Flammability of Plastics when tested with a sample of the compound having a thickness of no greater than 1.6 mm. In some aspects, the compound exhibits at least a V0 level flame resistance as measured by the UL 94 Test for Flammability of Plastics when tested with a sample of the compound having a thickness of no greater than 1.6 mm.

In some aspects, the compound exhibits at least a V2 level flame resistance as measured by the UL 94 Test for Flammability of Plastics when tested with a sample of the compound having a thickness of no greater than two mm In some aspects, the compound exhibits at least a V1 level flame resistance as measured by the UL 94 Test for Flammability of Plastics when tested with a sample of the compound having a thickness of no greater than two mm. In some aspects, the compound exhibits at least a V0 level flame resistance as measured by the UL 94 Test for Flammability of Plastics when tested with a sample of the compound having a thickness of no greater than two mm.

In some aspects, the compound includes a liquid flame retardant component in an amount of at least 15% by weight, based on the total weight of the compound. In some aspects, the compound includes a liquid flame retardant component in an amount of at least 20% by weight, based on the total weight of the compound. In some aspects, the compound includes a liquid flame retardant component in an amount of at least 25% by weight, based on the total weight of the compound. In some aspects, the compound includes a liquid flame retardant component in an amount of at least 30% by weight, based on the total weight of the compound.

In some aspects, the compound includes an expanded graphite flame retardant component in an amount of at least one % by weight, based on the total weight of the compound. In some aspects, the compound includes an expanded graphite flame retardant component in an amount of at least two % by weight, based on the total weight of the compound. In some aspects, the compound includes an expanded graphite flame retardant component in an amount of at least five % by weight, based on the total weight of the compound. In some aspects, the compound includes an expanded graphite flame retardant component in an amount of at least seven % by weight, based on the total weight of the compound.

In some aspects, the compound is derived from a composition comprising a first component comprising an isocyanate reactive compound and a blowing agent, and a second component comprising an isocyanate compound. At least 15% by weight, based on the total weight of the composition, a first flame retardant component that is liquid at a temperature from 25° C. to 35° C.; and at least one % by weight based on the total weight of the composition, a second flame retardant comprising an expandable graphite. The first component, second component, first flame retardant and second flame retardant are configured to be combined to form a mixture having a viscosity no greater than 2000 cP within one minute after forming, when measured at an ambient temperature of about 25° C., with a Brookfield RVF viscometer at 50 rpm using an RV-3 spindle.

Disclosed herein is a battery module comprising a first electric cell potted in a foam compound. The foam compound has a density of less than 0 60 g/cm³, and the foam compound exhibits at least a V2 level flame resistance as measured by the UL 94 Test for Flammability of Plastics when tested with a sample of the foam compound having a thickness of no greater than one millimeter. In some aspects, the foam compound has a density of less than 0.60 g/cm³, and the foam compound exhibits at least a V1 level flame resistance as measured by the UL 94 Test for Flammability of Plastics when tested with a sample of the foam compound having a thickness of no greater than one millimeter. In some aspects, the foam compound has a density of less than 0.60 g/cm³, and the foam compound exhibits at least a V0 level flame resistance as measured by the UL 94 Test for Flammability of Plastics when tested with a sample of the foam compound having a thickness of no greater than one millimeter.

In some aspects, the foam compound exhibits at least a V2 level flame resistance as measured by the UL 94 Test for Flammability of Plastics when tested with a sample of the foam compound having a thickness of no greater than two millimeters. In some aspects, the foam compound exhibits at least a V1 level flame resistance as measured by the UL 94 Test for Flammability of Plastics when tested with a sample of the foam compound having a thickness of no greater than two millimeters. In some aspects, the foam compound exhibits at least a V0 level flame resistance as measured by the UL 94 Test for Flammability of Plastics when tested with a sample of the foam compound having a thickness of no greater than two millimeters. In some aspects, the foam compound exhibits at least a V1 level flame resistance as measured by the UL 94 Test for Flammability of Plastics when tested with a sample of the foam compound having a thickness of no greater than 6.5 mm.

In some aspects, the foam compound exhibits a compressive strength of of at least 20 psi, when measured with the Foam Integrity Test with a sample of the foam compound having a thickness of no greater than one millimeter. In some aspects, the foam compound exhibits a compressive strength of of at least 20 psi, when measured with the Foam Integrity Test with a sample of the foam compound having a thickness of no greater than two millimeters. In some aspects, the foam compound exhibits a compressive strength of of at least 20 psi, when measured with the Foam Integrity Test with a sample of the foam compound having a thickness of no greater than three millimeters.

In some aspects, the foam compound includes a liquid flame retardant component in an amount of at least 15% by weight, based on the total weight of the compound. In some aspects, the foam compound includes a liquid flame retardant component in an amount of at least 20% by weight, based on the total weight of the compound. In some aspects, the foam compound includes a liquid flame retardant component in an amount of at least 25% by weight, based on the total weight of the compound. In some aspects, the foam compound includes a liquid flame retardant component in an amount of at least 30% by weight, based on the total weight of the compound.

In some aspects, the foam compound includes an expanded graphite flame retardant component in an amount of at least one % by weight, based on the total weight of the compound. In some aspects, the foam compound includes an expanded graphite flame retardant component in an amount of at least two % by weight, based on the total weight of the compound. In some aspects, the foam compound includes an expanded graphite flame retardant component in an amount of at least five % by weight, based on the total weight of the compound. In some aspects, the foam compound includes an expanded graphite flame retardant component in an amount of at least seven % by weight, based on the total weight of the compound.

In some aspects, the foam compound is at least one of a polyurethane foam compound, a silicone foam compound, and an epoxy-based foam compound. In some aspects, the foam compound is derived from a composition comprising a first component comprising an isocyanate reactive compound and a blowing agent; a second component comprising an isocyanate compound; at least 15% by weight, based on the total weight of the composition, a first flame retardant component that is liquid at a temperature from 25° C. to 35° C.; and at least one % by weight based on the total weight of the composition, a second flame retardant comprising an expandable graphite. The first component, second component, first flame retardant and second flame retardant are configured to be combined to form a mixture having a viscosity no greater than 2000 cP within one minute after forming, when measured at an ambient temperature of about 25° C., with a Brookfield RVF viscometer at 50 rpm using an RV-3 spindle.

Disclosed herein is a battery module including a foam compound, and an electric cell potted in the compound. The foam compound including a liquid flame retardant component in an amount of at least 15% by weight, based on the total weight of the compound, and at least one % by weight based on the total weight of the composition, a second flame retardant comprising an expandable graphite.

In some aspects, the foam compound exhibits a compressive strength of of at least 20 psi, when measured with the Foam Integrity Test with a sample of the foam compound having a thickness of no greater than one millimeter. In some aspects, the battery module includes a plurality of electric cells, each electric cell having a bottom, a top, and a length defined therebetween, the compound being at a substantially level height.

In some aspects, the foam compound exhibits at least a V1 level flame resistance as measured by the UL 94 Test for Flammability of Plastics when tested with a sample of the polyurethane foam compound having a thickness of no greater than one millimeter. In some aspects, the foam compound exhibits at least a V0 level flame resistance as measured by the UL 94 Test for Flammability of Plastics when tested with a sample of the polyurethane foam compound having a thickness of no greater than one millimeter.

In some aspects, the foam compound includes the liquid flame retardant component in an amount of at least 20% by weight, based on the total weight of the compound. In some aspects, the foam compound includes the liquid flame retardant component in an amount of at least 25% by weight, based on the total weight of the compound. In some aspects, the foam compound includes the liquid flame retardant component in an amount of at least 30% by weight, based on the total weight of the compound. In some aspects, the foam compound includes the second flame retardant component in an amount of at least two % by weight, based on the total weight of the compound. In some aspects, the foam compound includes the second flame retardant component in an amount of at least three % by weight, based on the total weight of the compound.

In some aspects, the foam compound includes the second flame retardant component in an amount of at least five % by weight, based on the total weight of the compound.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a perspective view of a battery module, in accordance with certain embodiments.

FIG. 2 is a top view of a battery module, in accordance with certain embodiments.

FIG. 3 is a front view of a battery module, in accordance with certain embodiments.

FIG. 4 is a perspective view of a battery module, in accordance with certain embodiments.

FIG. 5 is a top view of a battery module, in accordance with certain embodiments.

FIG. 6 is an exploded view of a battery module, in accordance with certain embodiments.

### DEFINITIONS

As used herein, a potting compound is defined as a solid material used to embed an object in a container and hold the object in spatial relation to the container.

As used herein, a potting composition is defined as a liquid composition suitable for solidifying to form a potting compound.

As used herein, room temperature is defined as a temperature between 22° C. and 25° C.

As used herein, a foam is defined as a material formed from a bulk component that defines voids throughout the material.

As used herein, self-leveling is defined as exhibiting the property of being able to flow to form a level surface without the application of external forces other than gravity.

### DETAILED DESCRIPTION

Disclosed herein is a compound having flame retardant properties as measured with a sample of the compound having dimensions of at least 150 mm long by 13 mm wide and having a thickness of no greater than 9.5 mm, 6.35 mm, 3.2 mm, 1.6 mm, or even 1.0 mm. The compound has at least a V2 level flame resistance as measured by the UL 94 Test for Flammability of Plastics with a strip of sample compound at least 150 mm long by 13 mm wide and having a thickness of no greater than 9.5 mm, 6.35 mm, 3.2 mm, 1.6 mm, or even no greater than 1.0 mm. In some embodiments, the compound has at least a V1 level flame resistance as measured by the UL 94 Test for Flammability of Plastics with a strip of sample compound at least 150 mm long by 13 mm wide and having a thickness of no greater than 9.5 mm, 6.35 mm. 3.2 mm. 1.6 mm, or even no greater than 1.0 mm. In some embodiments, the compound has at least a V0 level flame resistance as measured by the UL 94 Test for Flammability of Plastics with a strip of sample compound at least 150 mm long by 13 mm wide and having a thickness of no greater than 9.5 mm, 6.35 mm, 3.2 mm, 1.6 mm, or even no greater than 1.0 mm.

Disclosed herein is a compound having flame retardant properties and a density of no greater than 0.6 grams per cubic centimeter (g/cc), no greater than 0.5 g/cc, no greater than 0.4 g/cc, no greater than 0.3 g/cc, no greater than 0.2 g/cc, no greater than 0.18 g/cc, no greater than 0.16 g/cc, no greater than 0.14 g/cc, no greater than 1.2 g/cc, no greater than 1.0 g/cc, or even no greater than 0.05 g/cc.

Disclosed herein is a composition suitable for forming a compound that is low density and has flame retardant properties. Disclosed herein is a composition suitable for forming a flame retardant foam compound. Disclosed herein is a composition suitable for forming a compound that is low density, is flame retardant, and exhibits a compressive strength of at least 20 psi, at least 25 psi, at least 30 psi, at least 40 psi, at least 50 psi, at least 60 psi, at least 70 psi, or even at least 75 psi after undergoing the Foam Integrity Test disclosed herein.

### Composition

In some embodiments, the composition may be a one-part composition. In some embodiments, the compositions may be a two-part composition. In some embodiments, the composition may be a one-part composition that contains at least a first flame retardant composition. In some embodiments, the composition may be a two-part composition formed from a first component that is reacted with a second component. At least one of the first component or the second component contains a first flame retardant component.

In some embodiments, the composition may include silicone, epoxy, for example a one- or two-component epoxy resin, bio-based components, or polyurethane. In some embodiments, the first component and the second component may be selected to form a thermoplastic polyurethane component (TPU). The composition may be a liquid that cures to form a solid compound. The composition can be positioned when in a liquid phase and flow around an object and through spaces defined between adjacent objects before curing to form a solid compound. The composition can have sufficient flowability before curing to be poured as a liquid which can flow around an object and settle at a level height around the object. The composition can be self-leveling.

In some embodiments, the composition exhibits a viscosity of no greater than 100 centipoise (cP); 200 cP; 300 cP; 400 cP; 500 cP; 600 cP; 700 cP, 800 cP; 900 cP, 1,000 cP; 1,100 cP; 1,200 cP; 1,300 cP; 1,400 cP; 1,500 cP; 2,000 cP; 2,500 cP; 3,000 cP; 3,500 cP; 4,000 cP; 4,500 cP; 5,000 cP; 5500 cP; 6,000 cP; 7,000 cP; 8,000 cP; 9,000 cP; about 10,000; about 20,000; about 30,000; about 40,000; or about 100,000, at room temperature.

### First Component

The first component is a liquid at room temperature. In some embodiments, the first component has a viscosity from greater than one to less than 100,000 cP at room temperature. In some embodiments, the first component has a viscosity of no greater than 100,000 cP; 40,000; 30,000, 20,000; 10,000 cP; 9,000 cP; 8,000 cP; 7,000 cP: 6,000 cP; 5,500 cP; 5,000 cP; 4,500 cP; 4000 cP; 3,500 cP, 3,000 cP; 2,500 cP; 2,000 cP; 1,500 cP; 1,400 cP: 1,300 cP: 1,200 cP; 1,100 cP; 1,000 cP; 900 cP; 800 cP; 700 cP; 600 cP; 500 cP; 400 cP; 300 cP; 200 cP; or even no greater than 100 cP, at room temperature.

In some embodiments, the first component has a viscosity from about 100 cP; 200 cP: 300 cP; 400 cP; 500 cP; 600 cP; 700 cP; 800 cP; 900 cP; 1,000 cP; 1,100 cP; 1,200 cP; 1,300 cP; 1,400 cP: 1,500 cP; 2,000 cP; 2,500 cP; 3,000 cP; 3,500 cP; 4,000 cP; or 4,500 cP; to 5,000 cP; 5500 cP; 6,000 cP; 7,000 cP; 8,000 cP: 9,000 cP; about 10,000; about 20,000; about 30,000; about 40,000, or about 100,000, or a viscosity between any pair of the foregoing values, at room temperature.

In some embodiments, the first component includes one or more isocyanate reactive compounds. The isocyanate reactive compound may be a compound containing an active hydrogen, for example an amine, an alcohol, or thiol. The first component may include an isocyanate reactive compound having a functionality of two or more. Preferred isocyanate reactive compound may be those having a functionality of three or more.

Suitable isocyanate reactive compounds are those that are liquid at room temperature. Preferred isocyanate reactive compounds are those that have a low viscosity at room temperature.

In some embodiments, a suitable isocyante reactive compound has a viscosity of no greater than 10,000 cP, 9,000 cP; 8,000 cP; 7,000 cP; 6,000 cP; 5,500 cP, 5,000 cP, 4,500 cP; 4000 cP: 3,500 cP; 3,000 cP; 2,500 cP: 2,000 cP: 1,500 cP; 1,400 cP; 1,300 cP; 1,200 cP; 1.100 cP; 1,000 cP; 900 cP; 800 cP; 700 cP; 600 cP; 500 cP; 400 cP; 300 cP; 200 cP; or even no greater than 100 cP, at room temperature.

In some embodiments, a suitable isocyante reactive compound may have a viscosity from about 100 cP; 200 cP; 300 cP; 400 cP; 500 cP; 600 cP; 700 cP, 800 cP; 900 cP, 1,000 cP; 1,100 cP: 1,200 cP; 1,300 cP; 1,400 cP; 1,500 cP; 2,000 cP; 2,500 cP: 3,000 cP: 3,500 cP; 4000 cP; or 4,500 cP; to about 5,000 cP; 5,500 cP; 6,000 cP; about 10,000; about 20,000; about 30,000; about 40,000; or about 100,000; or a viscosity between any pair of the foregoing values at room temperature

In some embodiments, the isocyanate reactive compound may be a polyol. The isocyanate reactive compound may be a combination of two or more polyols. For example, the isocyanate reactive compound may be a diol polyol, a triol polyol, tetra polyol or a higher order polyol, and combinations thereof. Preferred examples of polyols that may be used as the isocyanate reactive compound include those that have a low viscosity at room temperature.

In some embodiments, suitable polyols may include polyhydroxy ethers, including substituted or unsubstituted polyalkylene ether glycols or polyhydroxy polyalkylene ethers, polyhydroxy polyesters; the ethylene or propylene oxide adducts of polyols and the monosubstituted esters of glycerol; polymer polyols, for example graft polyols containing a proportion of a vinyl monomer, for example, that can be polymerized in situ; and mixtures and combinations thereof. Further examples of suitable polyols include poly(diethylene glycol adipate).

In some embodiments, a homopolymer and a copolymer of polyoxyalkylene may be used. In some embodiments, copolymers of the polyoxyalkylene polyols may include an adduct of at least one compound including ethylene glycol, propylene glycol, diethylene glycol, dipropylene glycol, triethylene glycol, 2-ethylhexanediol-1,3-glycerin, 1,2,6-hexane triol, trimethylol propane, trimethylol ethane, tris(hydroxyphenyl) propane, triethanolamine, triisopropanolamine; and one compound including ethylene oxide, propylene oxide and butylene oxide.

The polyol may be selected from the group consisting of a polyether polyol and a polyester polyol. Suitable polyether polyols include, but are not limited to, polyoxyalkylene polyols such as polyethylene glycol, polypropylene glycol, polytetramethylene glycol, polybutylene glycol, and mixtures and combinations thereof. In some embodiments, a suitable polyether polyol may have a number average molecular weight (Mₙ) of less than 10,000; 9,000; 8,000; 7,000; 6,000; 5,000; 4,000; 3,000, 2,000; 1,000, or even less than 900, 800, 700, 600, 500, 400, 300, 200, or less than 100. In some embodiments, a suitable polyether polyol may have a number average molecular weight (Mₙ) from 100, about 200, about 300, about 400, about 600, to about 800, about 1,000, about 4,000, about 6,000, about 7,000, or about 10,000, or a molecular weight between any pair of the foregoing values.

In some embodiments, a suitable polyester polyol can be formed from the reaction of one or more polyhydric alcohols having from about two to about 15 carbon atoms with one or more polycarboxylic acids having from about two to about 14 carbon atoms. Examples of suitable polyhydric alcohols include ethylene glycol, propylene glycol such as 1,2-propylene glycol, 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol mono ethyl ether, diethylene glycol, 2-ethylhexanediol, 1,4-cyclohexanediol, 1,2,6-hexanetriol, 1,3,5-hexanetriol, 1,3-bis-(2-hydroxyethoxy) propane and similar components

In some embodiments, the isocyanate reactive compound is present in the first component at a weight percent from about 20 percent, about 30 percent, or about 40 percent, to about 70 percent, about 80 percent, about 90 percent, or about 100 percent, or a weight percent between any pair of the foregoing values, based on the total weight of the first component. In some embodiments, the isocyanate reactive compound is present in the first component at a weight percent of at least 20 percent. 25 percent, 30 percent, 35 percent, 40 percent, 45 percent, or at least 50 percent, based on the total weight of the first component. In embodiments having more than one isocyanate reactive compound, the total amount of all isocyanate reactive compounds present in the first component have a combined weight percent from about 20 percent, about 30 percent, or about 40 percent, to about 70 percent, about 80 percent, about 90 percent, or about 100 percent, or a weight percent between any pair of the foregoing values, based on the total weight of the first component.

Suitable commercially available polyols that may be used include the triol polyether polyol available under the trade designations POLY-G 30-240 or POLY-G 30-238 (available from Monument Chemical Group, of Brandenburg, KY, USA), the triol polyether polyol available under the trade designation VORANOL 230-238 (available from the Dow Chemical Company, of Midland, MI. USA), and the polyether polyol sold under the trade designation ARCOL LHT-240 (available from Covestro AG, of Leverkusen, Germany).

### Second Component

In embodiments containing a second component, the second component is a liquid at room temperature. The second component has a viscosity of less than 100,000 cP at room temperature. In some embodiments, the second component has a viscosity from about 100 cP; 200 cP; 300 cP, 400 cP; 500 cP, 600 cP; 700 cP; 800 cP; 900 cP; 1,000 cP; 1,100 cP, 1,200 cP; 1,300 cP; 1,400 cP; 1,500 cP; 2,000 cP; 2,500 cP: 3,000 cP; 3,500 cP; 4000 cP: or 4,500 cP; to about 5,000 cP; 5,500 cP; 6,000 cP; about 10,000; about 20,000; about 30,000, about 40,000; or about 100,000, or a viscosity between any pair of the foregoing values. In some embodiments, the second component has a viscosity no greater than 2,000 cP; 1,500 cP; 1,000 cP, 800 cP; 600 cP; 400 cP; 200 cP, or even no greater than 100 cP, at room temperature.

The second component may include an isocyanate compound. The isocyanate compound may have an average isocyanate functionality of two or greater. In some embodiments, suitable isocyanate compounds include those exhibiting a viscosity no greater than 2,000 cP; 1,500 cP; 1,000 cP; 800 cP, 600 cP; 400 cP, 200 cP, or even no greater than 100 cP, at room temperature.

In some embodiments, the isocyanate compound may be a monomer. In some embodiments, the isocyanate compound may be a polymer. In some embodiments, the isocyanate compound may be a prepolymer. For example, the isocyanate compound may be a polymer that is reacted with a second isocyanate compound, such as an isocyanate terminated oligomer. In some embodiments, the isocyanate compound may be a polymeric isocyanate.

In some embodiments, a suitable isocyanate compound has a viscosity of no greater than 10,000 cP; 9,000 cP; 8,000 cP; 7,000 cP; 6,000 cP: 5,500 cP; 5,000 cP; 4,500 cP; 4000 cP: 3,500 cP; 3,000 cP; 2,500 cP; 2,000 cP; 1,500 cP; 1,400 cP, 1,300 cP; 1,200 cP; 1,100 cP; 1,000 cP; 900 cP; 800 cP; 700 cP; 600 cP; 500 cP; 400 cP; 300 cP; 200 cP; or even no greater than 100 cP, at room temperature. For example, a suitable polymeric isocyanate has a viscosity of no greater than 10,000 cP; 9,000 cP: 8,000 cP; 7,000 cP: 6,000 cP; 5,500 cP; 5,000 cP; 4,500 cP; 4000 cP; 3,500 cP; 3,000 cP; 2,500 cP: 2,000 cP; 1,500 cP; 1,400 cP; 1,300 cP; 1,200 cP; 1,100 cP; 1,000 cP; 900 cP; 800 cP; 700 cP; 600 cP; 500 cP, 400 cP; 300 cP, 200 cP; or even no greater than 100 cP, at room temperature.

Suitable isocyanate compounds include, but are not limited to, aromatic isocyanates such as aromatic diisocyanates, or aliphatic isocyanates such as aliphatic diisocyanates. In some embodiments, the isocyanate compound has from one to 10 aliphatic or aromatic groups substituted by the isocyanate group.

Suitable isocyanate compounds include methylene diphenyl isocyanate compounds such as diphenyl methane diisocyanate (including its isomers), methylene diphenyl diisocyanate (MDI), carbodiimide modified MDI, hydrogenated methylene diphenyl isocyanate (HMDI), hexamethylene diisocyanate (HDI), isophorone diisocyanate (IPDI), polymeric methylene diphenyl isocyanate, diphenylmethane-4,4′-diisocyanate, diphenylmethane-2,2′-diisocyanate, diphenylmethane-2,4′-diisocyanate, and other oligomeric methylene isocyanates; toluene diisocyanate compounds (TDI) (including isomers thereof), tetramethylxylene diisocyanate (TMXDI), isomers of naphthylene diisocyanate, isomers of triphenylmethane triisocyanate, and mixtures and combinations thereof. In some instances, aliphatic di, tri, and polyisocyanates are also suitable isocyanate compounds, including, for example, hydrogenated aromatic diisocyanates, aliphatic polyisocyanates, or cycloaliphatic polyisocyanates.

Suitable isocyanate compounds that are commercially available include the modified liquid MDI sold under the trade designation ISONATE 143L (available from The Dow Chemical Company, of Midland, MI, USA), and the polymeric MDI sold under the trade designation RUBINATE M (available from Huntsman Corporation, of The Woodlands, TX, USA).

In some embodiments, the isocyanate compound is present in the second component at a weight percent from about 20 percent, about 30 percent, or about 40 percent, to about 70 percent, about 80 percent, about 90 percent, or about 100 percent, or a weight percent between any pair of the foregoing values, based on the total weight of the second component. In some embodiments, the isocyanate compound is present in the second component at a weight percent of at least 50 percent, 55 percent, 60 percent, 70 percent, 75 percent, 80 percent, at least 85 percent, at least 90 percent based on the total weight of the second component In embodiments having more than one isocyanate compound, the total amount of all isocyanate compounds present in the second component have a combined weight percent from about 20 percent, about 30 percent, or about 40 percent, to about 70 percent, about 80 percent, about 90 percent, or about 100 percent, or a weight percent between any pair of the foregoing values, based on the total weight of the second component.

### Blowing Agent

In some embodiments, the composition includes a blowing agent. In some embodiments, the blowing agent may be a gas. In some embodiments, the blowing agent may be a liquid.

For example, the blowing agent may be a gas that is injected into the composition to create voids, such as pockets of gas in the composition, once the composition is to be dispensed, such as when the components of the composition are mixed. Suitable blowing agents that may be injected into the composition include nitrogen, pentane (e.g., cyclopentane and isopentane), and carbon dioxide.

In some embodiments, suitable blowing agents are those that can react with the remaining components of the composition to create voids, such as pockets of gas. For example, useful blowing agents may react with the remaining components of the composition to form voids, such as bubbles of air or cavities defined by the composition.

Chemical blowing agents can include water, azodicarbonamide (e.g., for vinyl), hydrazine and other nitrogen-based materials for thermoplastic and elastomeric foams, and sodium bicarbonate for thermoplastic foams.

In some embodiments, the blowing agent is water. For example, for a compound to be formed from polyurethane, water may be included to react with the polyurethane-forming components to form carbon dioxide gas when the polyurethane components are mixed. The carbon dioxide gas forms bubbles in the liquid composition. The bubbles form cavities in the polyurethane after it cures and hardens, resulting in a foam compound.

In some embodiments, the blowing agent may be included in the first component. For example, in some embodiments, the blowing agent may be a liquid blowing agent included in the first component.

In some embodiments, the blowing agent is present in the composition at a weight percent from greater than zero, about 0.1 percent, about 0.5 percent, or about 1.0 percent, to about 1.5 percent, about 2.0 percent, about 2.5 percent, about 3.0 percent, about 4.0 percent, or a weight percent between any pair of the foregoing values, based on the total weight of the first component.

In some embodiments, a low-density compound may be formed with a composition that includes micro balloons, such as expanded or unexpanded balloons, e.g., syntactic foams. For example, solid particles formed from glass or polymeric materials may be used to form a three-dimensional shape, such as a bead or bubble, defining a gas-filled center. The beads or bubbles may be distributed throughout a bulk substance that can cure and entrap the beads or bubbles, thus decreasing the overall density of the cured material.

### First Flame Retardant Component

The composition includes at least one first flame retardant component. The first flame retardant component is preferably a liquid at room temperature. In compositions formed from a first and second component, the flame retardant component may be present in one, or both, of the first and second components. In some embodiments, in compositions formed from a first and second component, the flame retardant component may be added to a composition having the first and second component combined.

In some embodiments, a suitable flame retardant component exhibits a viscosity of no greater than 2,000 cP; 1,500 cP; 1,000 cP; 800 cP; 600 cP; 400 cP: 200 cP; or even no greater than 100 cP, at room temperature. Suitable first flame retardant components include those having a viscosity from about 30 cP, about 40 cP, about 100 cP, about 200 cP, about 300 cP or about 400 cP, to about 600 cP, about 700 cP, about 800 cP, or about 900 cP, or about 2000 cP, or a viscosity between any pair of the foregoing values, at room temperature.

In some embodiments, preferred liquid flame retardant components include those having a viscosity no greater than about 300 cP at room temperature. For example, preferred liquid flame retardant components include those having a viscosity from about 40, about 60, or about 80, or about 100, to about 150, about 200, about 250, or about 300, or a viscosity between any pair of the foregoing values, at room temperature.

In some embodiments, the first flame retardant component may be a non-halogenated flame retardant. In some embodiments, the first flame retardant component may be a halogenated flame retardant.

In some embodiments, the first flame retardant component includes a phosphate ester. The first flame retardant component may include a non-halogenated phosphate ester. The first flame retardant component may include a halogenated phosphate ester. The first flame retardant component may include one or both of a brominated phosphate ester and a chlorinated phosphate ester. For example, a suitable liquid flame retardant that may be used as the first flame retardant may be tris (2-chloroisopropyl) phosphate. The first flame retardant component may include a liquid phosphorous polyol.

The first flame retardant component may include one or more brominated organic compounds including brominated diols, brominated mono-alcohols, brominated ethers, brominated phosphates, and combinations thereof. Brominated organic compounds suitable as a first flame retardant component include tetrabromobisphenol-A, hexabromocyclododecane, poly(pentabromobenzyl acrylate), pentabromobenzyl acrylate, tetrabromobisphenol A-bis(2,3-dibromopropyl ether), tribromophenol, dibromoneopentyl glycol, tribromoneopentyl alcohol, tris(tribromoneopentyl) phosphate, and 4,4′-isopropylidenebis[2-(2,6-dibromophenoxy) ethanol], and combinations thereof.

In some embodiments, suitable commercially available flame retardants that may be included as a first flame retardant component are the phosphate ester flame retardant available under the trade designation FYROL A710, the non-halogenated phosphate ester flame retardant available under the trade designation FYROLFLEX RDP, the chlorinated phosphate ester available under the trade designation FYROL PCF, the butylated triphenyl phosphate ester available under the trade designation PHOSFLEX 71B (all available from ICL Industrial Products, of St. Louis, MO, USA); the brominated flame retardant (ethylenebistetrabromophthalimide) available under the trade designation SAYTEX BT-93 (from Albemarle Corporation, of Baton Rouge, LA, USA); the phosphorous flame retardant (isopropylated triaryl phosphate ester) available under the trade designation REOFOS 35, from Lanxess Aktiengesellschaft, of Cologne, Germany); the flame retardants cresyl diphenyl phosphate (available under the trade designation KRONITEX CDP) or zinc borate (available under the trade designation ZB-467) (both from Lanxess Aktiengesellschaft); and the flame retardant enhancers available under the trade designations FIREBLEND AF-100 (from The St. Louis Group of Indianapolis, IN, USA) and ADINS FIREPROOF 20 (from Tolsa SA, of Madrid, Spain).

In some embodiments, one or more first flame retardant components may be included in the composition, and the total amount of the one or more first flame retardant components in the composition is a weight percent of at least 10 percent, 15 percent, 17 percent, 20 percent, 25 percent, 30 percent, 40 percent, 50 percent, 60 percent, or at least 70 percent, based on the total weight of the composition. In some embodiments, one or more first flame retardant components may be included in the composition, and the total amount of the one or more first flame retardant components in the composition is a weight percent of from about 10 percent, 15 percent, 17 percent, 20 percent, 25 percent, 30 percent, or 35 percent, to 40 percent, 45 percent, 50 percent, 55 percent, 60 percent, 64 percent, or about 70 percent or a weight percent between any pair of the foregoing values, based on the total weight of the composition.

In embodiments having two components, the first flame retardant component can be included in at least one of the first or second component. In some embodiments, the first flame retardant component may be included in both the first component and the second component.

In some embodiments, the first flame retardant component is included in at least one of the first or second component at a weight percent of at least 10 percent, 15 percent, 20 percent, 25 percent, 30 percent, 40 percent, 50 percent, 60 percent, or at least 70 percent, based on the total weight of the component (either the first or the second component) that the first flame retardant component is present in. The first flame retardant component may be included in at least one of the first or second component at a weight percent from greater than zero percent, about 10 percent, about 15 percent, 17 percent, about 20 percent, about 25 percent, or about 30 percent, to about 40 percent, about 50 percent, or about 60 percent, about 70 percent, or a weight percent between any pair of the foregoing values, based on the total weight of the component (either the first or the second component) that the first flame retardant component is present in.

In some embodiments, two or more first flame retardant components may be included in at least one of the first or second component, and the total amount of the one or more first flame retardant components in the first or second component is a weight percent of at least 10 percent, 15 percent, 17 percent, 20 percent, 25 percent, 30 percent, 40 percent, 50 percent, 60 percent, or at least 70 percent, based on the total weight of the component (either the first or the second component) that the two or more first flame retardant components are present in. In some embodiments, two or more first flame retardant components may be included in at least one of the first or second component, and the total amount of the one or more first flame retardant components in the first or second component is a weight percent of from about 10 percent, 15 percent, 17 percent, 20 percent, 25 percent, 30 percent, or 35 percent, to 40 percent, 45 percent, 50 percent, 55 percent, 60 percent, 64 percent, or about 70 percent or a weight percent between any pair of the foregoing values, based on the total weight of the component (either the first or the second component) that the two or more first flame retardant components are included in.

A suitable amount of first flame retardant in the composition will provide suitable levels of flame retardancy without compromising other desirable characteristics. For example, in some instances the stiffness, hardness, flexibility, compressive strength, durability, modulus, or structural resilience of certain foam compounds may be unsuitable when unsuitably high levels of flame retardant are present. For example, in some embodiments, a suitable weight percent of first flame retardant component in a foam (such as a polyurethane foam) to provide a suitable level of flame retardancy and provide a compound having suitable mechanical or structural properties may be an amount of from 10 percent, 15 percent. 20 percent 25 percent, about 30 percent, or about 35 percent, to about 40 percent, about 45 percent, about 50 percent, about 55 percent, or about 60 percent based on the total weight of the polyurethane foam. In some embodiments, a suitable weight percent of first flame retardant component in a polyurethane foam (such as a polyurethane foam) to provide a suitable level of flame retardancy and provide a compound having suitable mechanical or structural properties may be an amount of at least 10 percent, 15 percent, 20 percent 25 percent, 30 percent, 35 percent, 40 percent, 45 percent, 50 percent, 55 percent, or at least 60 percent based on the total weight of the foam.

### Second Flame Retardant Component

The composition can include a second flame retardant component that is different than the first flame retardant component. In some embodiments, the composition includes two or more flame retardant components. In some embodiments, compositions formed from two or more components, the first component may include a first flame retardant component and the second component may include a second flame retardant component.

The second flame retardant component may be a liquid at room temperature. The second flame retardant component may be a solid at room temperature. In some embodiments, the first flame retardant component may be a liquid at room temperature, and the second flame retardant component may be a solid at room temperature For example, the second flame retardant component may be in a powdered form at room temperature.

In some embodiments, the second flame retardant component may be a non-halogenated flame retardant. In some embodiments, the flame retardant component may be a halogenated flame retardant.

In some embodiments, a preferred second flame retardant component may be a graphite-based flame retardant. For example, a graphite-based flame retardant such as an expandable graphite may be suitable as a second flame retardant component For example, the first flame retardant component may be a liquid at room temperature, and the second flame retardant component may be a graphite-based flame retardant in a powdered form at room temperature.

In some embodiments, a suitable commercially available flame retardant component that may be used as a second flame retardant component includes the graphite-based flame retardant sold under the trade designation GRAFGUARD (from NeoGraf Solutions, LLC, of Lakewood, OH, USA), the graphite-based flame retardant available under the trade designation NYAGRAPH 35 (from Nycol Nanotechnologies, of Ashland, MA, USA); the phosphorous flame retardant (isopropylated triaryl phosphate ester) available under the trade designation REOFOS 35, from Lanxess Aktiengesellschaft, of Cologne, Germany); the flame retardants cresyl diphenyl phosphate (available under the trade designation KRONITEX CDP) or zinc borate (available under the trade designation ZB-467) (both from Lanxess Aktiengesellschaft); the red phosphorus flame retardant available under the trade designation EXOLET RP 607 (from Clariant AG, of Muttenz, Switzerland); ammonium polyphosphate available under the trade designation EXOLET AP 423 or aluminum diethylphosphinate available under the trade designation EXOLIT OP 945 (both from Clariant); melamine polyphosphate available under the trade designation MELAPURE 200 (from BASF, of Ludwigshafen, Germany); pentaerythritol available under the trade designation CHARMORE PT40 (from Perastorp AB, of Malmö, Sweden); and the flame retardant enhancers available under the trade designation FIREBLEND AF-100 (from The St. Louis Group of Indianapolis, IN, USA) and ADINS FIREPROOF 20 (from Tolsa SA, of Madrid, Spain).

In embodiments having two components, the second flame retardant component can be included in at least one of the first or second component. In some embodiments, the second flame retardant component may be present in both the first component and the second component.

In some embodiments, a second flame retardant component may be included in the composition, and the total amount of the second flame retardant components in the composition is a weight percent of at least 0.5 percent, at least one percent, two percent, three percent, four percent, five percent, six percent, seven percent, eight percent, nine percent, 10 percent, 11 percent, 12 percent, 13 percent, 14 percent, 15 percent, 16 percent, 17 percent, 18 percent, 19 percent, or at least 20 percent, based on the total weight of the composition. In some embodiments, a second flame retardant component may be included in the composition, and the total amount of the second flame retardant component in the composition is a weight percent of from greater than zero percent, from 0 5 percent, about one percent, about two percent, about three percent, about four percent, about five percent, about six percent, about seven percent, or about eight percent, to about nine percent, about 10 percent, about 11 percent, about 12 percent, about 13 percent, about 14, about 15 percent, about 16 percent, about 17 percent, about 18 percent, about 19 percent, about 20 percent, or a weight percent between any pair of the foregoing values, based on the total weight of the composition.

In some embodiments, a second flame retardant component may be present in at least one of the first or second component at a weight percent of at least 0.5 percent, at least one percent, two percent, three percent, four percent, five percent, six percent, seven percent, eight percent, nine percent, 10 percent, 11 percent, 12 percent, 13 percent, 14 percent, 15 percent, 16 percent, 17 percent, 18 percent, 19 percent, or at least 20 percent, based on the total weight of the component (either the first or the second component) that the second flame retardant component is present in. In some embodiments, a second flame retardant component is present in at least one of the first or second component at a weight percent of greater than zero percent, 0.5 percent, about one percent, about two percent, about three percent, about four percent, about five percent, about six percent, about seven percent, or about eight percent, to about nine percent, about 10 percent, about 11 percent, about 12 percent, about 13 percent, about 14, about 15 percent, about 16 percent, about 17 percent, about 18 percent, about 19 percent, about 20 percent, or a weight percent between any pair of the foregoing values, based on the total weight of the component (either the first or the second component) that the second flame retardant component is present in.

In some embodiments, two or more second flame retardant components may be present in at least one of the first or second component, and the total amount of the two or more second flame retardant components in the first or second component is a weight percent of at least 0.5 percent, at least one percent, two percent, three percent, four percent, five percent, six percent, seven percent, eight percent, nine percent, 10 percent, 11 percent, 12 percent, 13 percent, 14 percent, 15 percent, 16 percent, 17 percent, 18 percent, 19 percent, or at least 20 percent, based on the total weight of the component (either the first or the second component) that the two or more second flame retardant components are included in. In some embodiments, two or more second flame retardant components may be present in at least one of the first or second component, and the total amount of the two or more second flame retardants in the first or second component is a weight percent of greater than zero percent, 0.5 percent, about one percent, about two percent, about three percent, about four percent, about five percent, about six percent, about seven percent, or about eight percent, to about nine percent, about 10 percent, about 11 percent, about 12 percent, about 13 percent, about 14, about 15 percent, about 16 percent, about 17 percent, about 18 percent, about 19 percent, about 20 percent, or a weight percent between any pair of the foregoing values, based on the total weight of the component (either the first or the second component) that the two or more second flame retardant components are included in.

In some embodiments, the first flame retardant component may be present in one or both of the first and second component at an amount from greater than zero percent, about 10 percent, about 15 percent, about 17 percent, about 20 percent, about 25 percent, or about 30 percent, to about 40 percent, about 50 percent, or about 60 percent, about 70 percent, or a weight percent between any pair of the foregoing values, based on the total weight of the component (either the first or the second component) that the first flame retardant component is present in; and the second flame retardant component may be present in at least one of the first or second component at a weight percent from greater than zero percent, about one percent, about two percent, about three percent, about four percent, about five percent, about six percent, about seven percent, or about eight percent, to about nine percent, about 10 percent, about 11 percent, about 12 percent, about 13 percent, about 14, about 15 percent, about 16 percent, about 17 percent, about 18 percent, about 19 percent, about 20 percent, or a weight percent between any pair of the foregoing values, based on the total weight of the component (either the first or the second component) that the second flame retardant component is present in.

It has been found that a suitable amount of both first and second flame retardant components will provide suitable levels of flame retardancy without compromising other desirable characteristics. For example, a suitable weight percent of second flame retardant component in a foam compound (such as polyurethane foam) to provide a suitable level of flame retardancy and provide a compound having suitable mechanical or structural properties may be an amount of greater than zero percent, about one percent, about two percent, about three percent, about four percent, about five percent, about six percent, about seven percent, or about eight percent, to about nine percent, about 10 percent, about 11 percent, about 12 percent, about 13 percent, about 14, about 15 percent, about 16 percent, about 17 percent, about 18 percent, about 19 percent, about 20 percent, or a weight percent between any pair of the foregoing values, based on the total weight of the foam compound. In some embodiments, a suitable weight percent of second flame retardant component in a foam compound (such as a polyurethane foam) to provide a suitable level of flame retardancy and provide a compound having suitable mechanical or structural properties may be an amount of at least 0.5 percent, at least one percent, two percent, three percent, four percent, five percent, six percent, seven percent, eight percent, nine percent, 10 percent, 11 percent, 12 percent, 13 percent, 14 percent, 15 percent, 16 percent, 17 percent, 18 percent, 19 percent, or at least 20 percent, based on the total weight of the foam compound.

### Optional Additional Additives

The composition may optionally include additional additives, either as separate components or mixed into one or more of the components described above to form the first and/or second component.

Examples of additional additives that may be added to either or both of the first or second components include, but are not limited to crosslinkers, chain extenders, humectants, thixotrops, nucleating agents, surfactants, diluents, anti-settling agents, flame-retardant enhancers, and components and combinations thereof. In some embodiments, the optional additional additives include waxes, release agents, antioxidants, reinforcing fillers, pigments, heat stabilizers, UV stabilizers, plasticizers, rheology modifiers, processing aids, lubricants, mold release agents, or component or combinations thereof. Suitable reinforcing fillers include mineral fillers and glass fibers.

Further examples of additional components include catalysts. In the example of a polyurethane composition, any conventional catalyst known to those of skill in the art can be used to react the isocyanate compound with the isocyanate reactive compound and the remaining components. Suitable catalysts include, but are not limited to triol catalysts, tetra polyol catalysts, or tertiary amine catalysts. Further examples of suitable catalysts include the various alkyl amines, alkyl ethers or alkyl thiol ethers, such as those of bismuth or tin wherein the alkyl portion has from one to about 20 carbon atoms. Some examples include bismuth octoate, bismuth laurate, and the like. Other catalysts include the various tin catalysts such as stannous octoate, dibutyltin dioctoate, dibutyltin dilaurate, and the like.

The optional additional additives disclosed herein may be present in the composition at a weight percent from greater than zero, about 0.1, about 0.5, or about one, to about five, about 10, about 20 percent, or about 30 percent, based on the total weight of the composition, or a weight percentage between any pair of the foregoing values. The weight percentage of the optional additional additives may be applied to the combined total of all additional additives present or to each additional additive separately.

In the example of a polyurethane composition, the amount of a catalyst present may from greater than zero, about 0.02, about 0.05, or about 0.1, to about 0.25, about 0.75, or about one percent, based on the total weight of the composition, or a weight percent between any pair of the foregoing values In some embodiments, a cross linker or humectant may be present in the composition at a weight percent from greater than zero, from about 0.1, about 0.5, or about one, to about five, about seven, or about 10 percent, based on the total weight of the composition, or a weight percent between any pair of the foregoing values. In some embodiments, a surfactant, for example suitable for stabilizing the foam structure or for helping with wet out, may be present in the composition at a weight percent from greater than zero, from about 0.1, about 0.5, or about one, to about two, about three, or about four percent, based on the total weight of the composition, or a weight percentage between any pair of the foregoing values. In some embodiments, a nucleating agent may be present in the composition at a weight percent from greater than zero, from about 0.1, or about 0.5, to about one, about 1.5, or about two percent, based on the total weight of the composition, or a weight percent between any pair of the foregoing values.

### Preparing the Composition

In embodiments of a composition having only a first component, the composition may be prepared by combining the first component with at least one flame retardant component. For example, a flame retardant silicone-based composition may be prepared by combining a first component that includes a silicone-based component with at least one of a first flame retardant component and second flame retardant component.

In embodiments of a composition having more than one component, for example, a two-component composition, the composition may be prepared by combining the first component with the second component, and at least one of a first flame retardant component and second flame retardant component. In some embodiments, the composition may be prepared by combining the first component with the second component, and at least one of the first component and second component can include at least one of a first flame retardant component and second flame retardant component.

### Polyurethane Compounds

In embodiments of a composition having more than one component, for example, a two-component composition, the first and second component are combined to form the composition having the flame retardant component. For example, in an embodiment of a polyurethane that forms a flame-retardant compound, the first and second component are mixed to form a composition having at least one flame-retardant component. After mixing the first component and the second component, the composition may be a blend of a polyurethane component and the at least one flame-retardant component. The flame retardant component system can include at least one of, or both, a first flame retardant component and second flame retardant component. The components of the composition having one or more flame-retardants are allowed to react to form a flame-retardant polyurethane compound.

In some embodiments, for example, in an embodiment of a polyurethane that forms a flame-retardant compound, a polyol may be included in the composition at a weight percent of at least five percent, about 10 percent, about 20 percent, about 30 percent or about 40 percent, to about 50 percent, about 60 percent, about 70 percent, or at least about 80 percent, based on the total weight of the composition. In an embodiment of a polyurethane that forms a flame-retardant compound, a polyether polyol may be included in the composition in a weight percent of at least 10 percent, about 20 percent, about 30 percent or about 40 percent, to about 50 percent, about 60 percent, about 70 percent, or at least about 80 percent, based on the total weight of the composition. In an embodiment of a polyurethane that forms a flame-retardant compound, a polyether polyol may be included in the composition at a weight percent from about five percent, about 10 percent, about 20 percent, about 30 percent or about 40 percent, to about 50 percent, about 60 percent, about 70 percent, or about 80 percent, or a weight percent between any pair of the foregoing values.

In some embodiments, the ratio of the weight amount of an isocyanate compound to the total equivalent weight amount of an isocyanate reactive component may be from about 0.60, about 0.65, about 0.70, or about 0.75, to about 0.80, about 0.85, about 0.90, or about 0.95, or a ratio between any pair of the foregoing values. In some embodiments, the ratio of isocyanate compound to isocyanate reactive compound is chosen such that an excess of reactive isocyanate equivalents in relation to the total number of isocyanate reactive groups on the isocyanate reactive compound is used.

Any known processes to react the first component with the second component may be used. In embodiments comprising a polyurethane composition, any process known to those skilled in the art for combining the first and second component to make a polyurethane foam may be used. In some embodiments, the process for combining may be a “one-shot” process where all the reactants are mixed and allowed to begin to react for a suitable period of time. In some embodiments, the reactants may be mixed and allowed to react for a suitable period of time before the composition is being positioned. In some embodiments, the reactants may be mixed as the composition is being positioned such that the reaction begins as the composition is being positioned. For example, the composition may be mixed, and a reaction of the components allowed to proceed for greater than one second before the composition is dispensed into a container that the composition will be allowed to cure in The composition may be mixed as the composition is dispensed into a container that the composition will be allowed to cure in, such that the reaction of the components begins immediately after (less than two seconds), or simultaneously as, the composition is dispensed into a container that the composition will be allowed to cure in.

### Foam Compounds

After curing, the compound may be in foam form. For example, the curing reaction may produce voids in the composition as the composition cures such that the resulting compound includes the cured composition defining voids throughout the compound. The voids may be filled with gas. The voids may be formed from the curing of the composition, for example, the reaction of the first component with the second component may release gas that forms bubbles in the composition. The voids may be formed from agitation of the composition, for example, by blowing a gas such as air or nitrogen gas into the composition as it cures.

For example, the composition may be a liquid mixture formed of components that react with each other and release a gas that forms voids in the form of bubbles defined by the composition. The liquid composition can solidify when cured and form the compound in a foam form comprised of the solidified composition defining voids throughout the compound. The foam compound has a lower density than if the potting compound was a solid mass without voids. The foam can be closed-cell or open-cell. Closed-cell refers to a foam having cavities that form discrete pockets completely surrounded by solid material. Open-cell refers to a foam having cavities that form pockets that connect to each other.

In some embodiments, the composition may include microballoons. As the composition hardens, the microballoons may become set in the hardened composition and become part of the resulting compound, thus creating a foam form.

In some embodiments, the compound in a foam form has a lower density than the combined density of the components that form the composition when the components are all in a liquid phase. In some embodiments, the compound has a density of no greater than 0.6 g/cc, no greater than 0.5 g/cc, no greater than 0.4 g/cc, no greater than 0.3 g/cc, no greater than 0.2 g/cc, no greater than 0.18 g/cc, no greater than 0.16 g/cc, no greater than 0.14 g/cc, no greater than 1.2 g/cc, no greater than 1.0 g/cc, or even no greater than 0.05 g/cc after curing. For example, the compound may be in a foam form and the foam may have a density from about 0.02 g/cc, about 0.05 g/cc, about 0.10 g/cc, about 0.20 g/cc, to about 0.30 g/cc, about 0.40 g/cc, about 0.50 g/cc, or no greater than 0.6 g/cc, or a density between any pair of the foregoing values.

### Flame Retardancy

The compositions disclosed herein are suitable for forming a foam compound exhibiting a suitable level of flame retardancy when measured with samples of the compound at dimensions having a length no greater than 150 mm long by 13 mm wide, and a thickness of from 1.0 millimeter (mm), 1.1 mm, 1.2 mm, 1.3 mm, 1.4 mm, 1.5 mm, 1.6 mm, 1.7 mm, 1.8 mm, 1.9 mm, 2.0 mm, or 2.1 mm, to 2.2 mm, 2.4 mm. 2.5 mm, 2.6 mm, 2.8 mm, 3.0 mm, 3.5 mm, 4.0 mm. 4.5 mm, 5.0 mm, 5.5 mm, 6.0 mm, 6.5 mm, or 7.0 mm, or a thickness between any pair of the foregoing values.

The compositions disclosed herein are suitable for forming a compound exhibiting at least a V2 level flame resistance as measured by the UL 94 Test for Flammability of Plastics when measured with samples of the compound having dimensions of no greater than 150 mm long by 13 mm wide and having a thickness of no greater than 9.5 mm, 6.35 mm, 3.2 mm, 1.6 mm, or even no greater than 1.0 mm, for example, a thickness of from 1.0 millimeter (mm), 1.1 mm, 1.2 mm. 1.3 mm, 1.4 mm, 1.5 mm, 1.6 mm, 1.7 mm, 1.8 mm, 1.9 mm, 2.0 mm, or 2.1 mm, to 2.2 mm, 2.4 mm. 2.5 mm, 2.6 mm, 2.8 mm, 3.0 mm, 3.5 mm, 4.0 mm. 4.5 mm, 5.0 mm, 5.5 mm, 6.0 mm, 6.5 mm, or 7.0 mm, or a thickness between any pair of the foregoing values.

In some embodiments, the compositions disclosed herein are suitable for forming a compound exhibiting at least a V1 level flame resistance as measured by the UL 94 Test for Flammability of Plastics when measured with samples of the compound having dimensions of no greater than 150 mm long by 13 mm wide and having a thickness of no greater than 9.5 mm, 6.35 mm, 3.2 mm, 1.6 mm, or even no greater than 1.0 mm; for example, a thickness of from 1.0 millimeter (mm), 1.1 mm, 1.2 mm, 1.3 mm, 1.4 mm, 1.5 mm, 1.6 mm, 1.7 mm, 1.8 mm, 1.9 mm, 2.0 mm, or 2.1 mm, to 2.2 mm, 2.4 mm. 2.5 mm, 2.6 mm, 2.8 mm, 3.0 mm, 3.5 mm, 4.0 mm. 4.5 mm, 5.0 mm. 5.5 mm, 6.0 mm, 6.5 mm, or 7.0 mm, or a thickness between any pair of the foregoing values.

In some embodiments, the compositions disclosed herein are suitable for forming a compound exhibiting at least a V0 level flame resistance as measured by the UL 94 Test for Flammability of Plastics when measured with samples of the compound having dimensions of no greater than 150 mm long by 13 mm wide and having a thickness of no greater than 9.5 mm, 6.35 mm, 3.2 mm, 1.6 mm, or even no greater than 1.0 mm; for example, a thickness of from 1.0 millimeter (mm), 1.1 mm, 1.2 mm, 1.3 mm, 1.4 mm, 1.5 mm, 1.6 mm, 1.7 mm, 1.8 mm, 1.9 mm, 2.0 mm, or 2.1 mm, to 2.2 mm, 2.4 mm. 2.5 mm, 2.6 mm, 2.8 mm, 3.0 mm, 3.5 mm, 4.0 mm. 4.5 mm, 5.0 mm. 5.5 mm, 6.0 mm, 6.5 mm, or 7.0 mm, or a thickness between any pair of the foregoing values.

### Potting Compound

The compositions disclosed herein are suitable for forming a potting compound. The composition is useful for potting one or more electric cells. The composition is useful for potting a plurality of electric cells in a battery module. The compound is useful for potting an electric cell and provide mechanical stability and flame retardancy after solidifying. The potting material may be in a foam form.

In some embodiments, the potting compound includes a polyurethane foam. The potting compound may be formed from a polyurethane composition that is a liquid before curing, and which hardens into a foam form as the potting compound. In some embodiments, the potting compound is formed from a polyurethane foam that has low density and includes a flame retardant.

The compositions disclosed herein are suitable for forming a potting compound that has a low density, is flame retardant, and that is a foam. The potting compound is suitable for use in forming a battery module. The compositions disclosed herein are suitable for forming a potting composition having suitable flowability to form the potting compound having a substantially level height throughout the battery module.

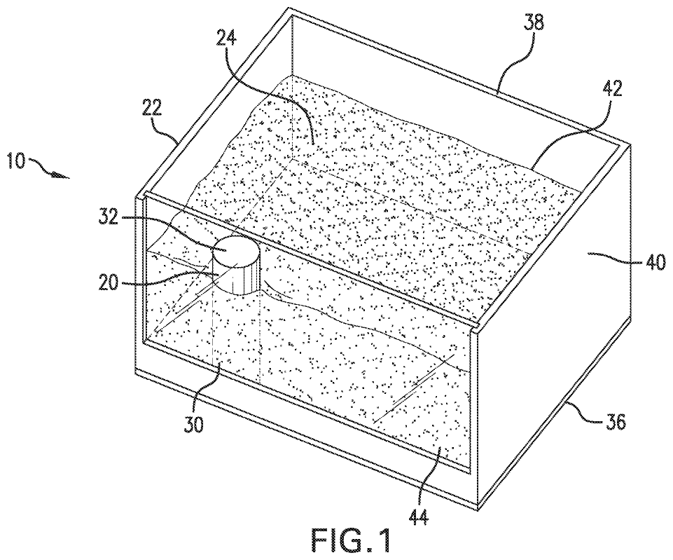

FIG. 1 is a perspective view of an example battery module 10. As shown in FIG. 1, the battery module 10 includes an electric cell 20 and a battery case 22. In some embodiments, the electric cell 20 may be positioned within the battery case 22 and potted in a potting compound 24. The electric cell 20 may be any suitable shape which generally has a bottom 30, a top 32 and a length defined therebetween. The battery case 22 may be any suitable shape for retaining the electric cell 20, and which generally has a bottom 36, a top 38, and a wall 40 defined therebetween. The bottom 36 of the battery case 22 defines an inner surface and an outer surface. The wall 40 of the battery case defines an inner surface and an outer surface. The battery case 22 defines an enclosed space having an internal volume. The potting compound 24 is positioned within the battery case 22 and occupies a portion of the internal volume of the battery case 22. The potting compound 24 generally has a top 42, a bottom 44, and a height defined therebetween.

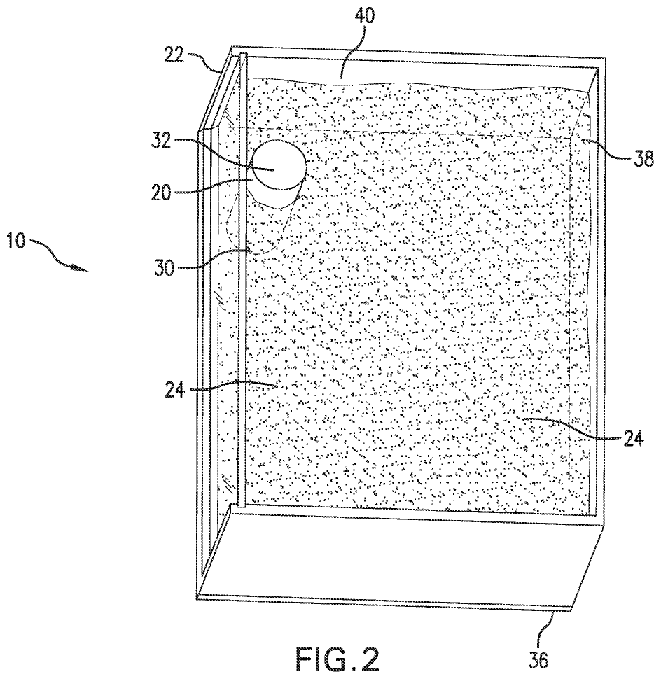

FIG. 2 is a top view of the battery module 10, shown in FIG. 1 As shown in FIG. 2, the battery case 22 forms an enclosed space that is large enough to surround the electric cell 20 and other components such as wires or connections. The enclosed space defines the internal volume of the battery case 22. The bottom 36 of the battery case 22 may be closed and contain any contents of the enclosed space. The top 38 of the battery case 22 may define an opening. The top 38 and/or the opening may be shaped and sized to receive a cover that can be closed to separate the internal volume of the enclosed space from the outside of the battery case 22. The cover can be configured to seal off the internal volume of the enclosed space from the outside of the battery case 22 to prevent entry of potential hazards such as fluids or flames. The battery case 22 may be designed and configured to provide mechanical or structural support to the electric cell 20. The battery case 22 may also be configured to provide protection from moisture, heat, cold, or any other potential factors that may cause damage to the electric cell 20.

As shown, in one possible arrangement, the electric cell 20 may be shaped as a cylinder. In further examples, the electric cell 20 may be formed into any suitable shape or size, as the need may be, such as a cube, sphere, cuboid, tetrahedron, cone, diamond, half sphere, pouch, or pyramid. The electric cell shown in FIG. 1 is shaped as a cylinder having the bottom 30, the top 32, and a wall extending between the bottom 30 and the top 32. The bottom 30 may be a positive terminal or may be a negative terminal of the electric cell 20, depending on the desired orientation. As shown, the bottom 30 of the electric cell 20 is positioned in the potting compound 24. The potting compound 24 occupies a portion of the internal volume of the battery case 22 and extends a substantially equal distance at various points along the wall 40 from the bottom 36 of the battery case 22 toward the top 38.

Electric cells may be used to form a battery. For example, multiple electric cells may be combined to form a single battery that has a higher voltage or amperage than a single electric cell.

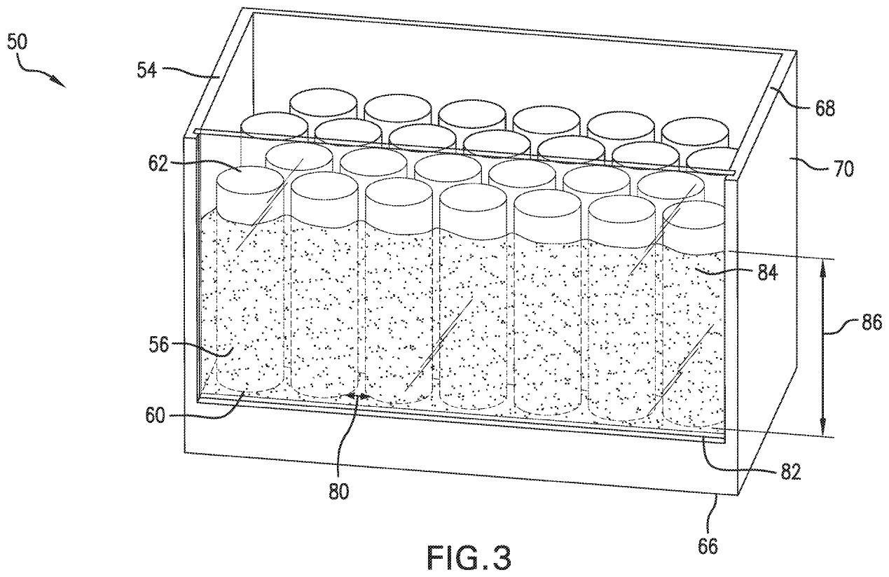

FIG. 3 is a front view of a battery module 50 that includes electric cells 52. Each of the electric cells 52 has a bottom 60, a top 62, and wall therebetween defining a length. The electric cells 52 may be positioned within a battery case 54. The electric cells 52 define a gap 80 between each electric cell and an adjacent electric cell. The gap 80 has a width The battery case 54 has a bottom 66, a top 68 and a wall 70 therebetween. The bottom 66, and the wall 70 define an enclosed space. The enclosed space of the battery case 54 defines an internal volume. The internal volume of the battery case 54 has a suitable volume to receive the electric cells 52 and a potting compound 56. The potting compound 56 has a bottom 82, a top 84, and a height 86 therebetween. The bottom 82 of the potting compound 56 is adjacent to the inside surface of the bottom 66 of the battery case 54. As shown, the top 84 of the potting compound 56 is between the bottom 66 and the top 68 of the battery case 54. Typically, the top 84 of the potting compound 56 is lower than the top 62 of the electric cells 52, although it is envisioned that in an alternative arrangement, the top 62 of the electric cells 52 may be lower than the top 84 of the potting compound 56.

As shown, multiple electric cells 52 may be arranged in close proximity to each other, with each of the electric cells 52 oriented with similarly charged terminals pointed in the same direction. Wires may be attached to the ends of the electric cells 52. The wires may be combined in electric communication such that the electric current from the electric cells 52 is combined, for example to form a battery having a combined current or voltage. The battery module 50 may be used to power any of a number of applications, such as a household appliance, outdoor electrical equipment, or a vehicle such as a car or a boat.

To combine the electric cells 52 to form a battery module, the electric cells 52 are connected with wires that conduct an electric current from the electric cells 52. The electric cells 52 are often arranged next to each other, for example in rows or stacked, to form an orderly arrangement for ease of use and/or for connecting the wires to the electric cell terminals. In the interest of conserving space, and to form a compact battery, the electric cells 52 may be positioned in close proximity to each other. For example, the electric cells 52 may be arranged in rows or as a grid, with the positive and negative terminals oriented in the same direction. The electric cells 52 may be positioned in an ordered arrangement and contained within the battery case 54, although it is envisioned that in some instances, a battery module may be formed without a battery case 54. For example, the electric cells 52 could be held together using an alternative securing device, such as a wire, string, band, etc. to hold the electric cells 52 in a bundle, for example.

In some instances, it may be desired to have a battery module that is portable, for instance in the case of a battery to start an ignition for, or to power a vehicle, such as a motorcycle, a car, or a boat, as some examples. In instances where the battery is desired to be portable, it is typically preferred to provide a battery that is structurally stable and made to with stand forces such as shock and/or vibrations. In some instances, it is also desired to provide a battery that is made to withstand extreme temperatures, including temperatures outside the normal operating temperature of the battery. For example, in some instances, the battery may be subjected to high heat, and possibly open flames. One possible source of flames may be one or more of the electric cells, for instance as a result of an electric short or if the structure of the electric cell wall is compromised. One example device that may be used to protect the electric cells 52 is the potting compound 56. The potting compound 56 may be associated with the electric cells 52, such as positioned around the electric cells 52 along one or more of the top, the bottom, or the wall of the electric cell. The electric cell or electric cells 52 may be encased or embedded in the potting compound 56 which holds the electric cells 52 in spatial relationship to one another and/or in spatial relationship to the battery case 54.

As shown in FIG. 3, the electric cells 52 are positioned in the potting compound 56. The potting compound 56 is positioned around each of the electric cells 52. In instances where the battery contains multiple electric cells 52, the potting compound 56 can be positioned around each electric cell, and in the gap 80 or spaces defined between individual electric cells 52. In instances where the battery is contained within the battery case 54, the potting compound 56 may be positioned between the electric cell or electric cells 52 and the battery case 54. The potting compound 56 may be positioned to provide suitable structural or mechanical support to the electric cells 52.

In some instances, the electric cells 52 may be positioned with a suitable distance between adjacent electric cells 52 such that individual electric cells 52 are thermally and/or fluidly isolated from each other in the event of a leak or fire. In some instances, the electric cells 52 may be positioned with a suitable distance between adjacent electric cells 52 such that a suitable thickness of potting compound 56 is positioned between adjacent electric cells 52 to provide sufficient shock dampening to prevent damage to the electric cells 52. The size of the space or gap SO between adjacent electric cells 52 and/or the battery case 54 can be selected based on a number of variables, including but not limited to, the size and/or weight of each electric cell, the operating temperature of each electric cell, the dimensions of each electric cell, and the intended use of the battery module 50. In some examples, the size of the space between adjacent electric cells may be from greater than zero mm, about 0.25 mm, about 0.50 mm, about 0.75 mm, to about 1.0 mm, about 1.5 mm, about 2.0 mm, about 2.5 mm, or about 3.0 mm, or a size between any pair of the foregoing values, although battery modules having additional configurations are further contemplated. In some examples, the size of the space between an electric cell and the battery case may be from greater than 0 mm, about 1.0 mm, about 2.0 mm, about 3.0 mm, to about 10 mm, about 12 mm, or about 14 mm, although battery modules having additional configurations are further contemplated.

In some embodiments, the potting compound 56 may be formed by first shaping a material such as a potting composition into a suitable shape with spaces defined by the potting compound 56 for holding one or more electric cells 52. The potting compound 56 may be formed by shaping a potting composition with a size and shape such that the potting compound 56 is positioned within the battery case 54 and defining one or more spaces to hold one or more electric cells 52 positioned in the spaces.

In some embodiments, the potting compound 56 may be formed by first arranging the electric cells 52 into the desired final position, for example, held together with wire or within the battery case 54. The electric cells 52 may be held in place in spatial relationship with one another using a mold or a scaffolding. The electric cells 52 may be held in place and positioned within a mold or other encasing surrounding the electric cells 52. In further examples, the electric cells 52 may be arranged in a desired final position in spatial relationship to one another and placed within the battery case 54, for example resting on the inside surface of the bottom 66 of the battery case 54. Once the desired arrangement of the electric cells 52 is attained, the potting compound 56 may be formed by flowing a potting composition around the electric cells 52 and through the gap 80 or spaces defined between adjacent electric cells 52. The potting composition may be applied as a liquid such that the potting composition flows through the gap 80 defined between adjacent electric cells 52 and between the electric cells 52 and the wall 70 of the battery case 54. As describe above, the potting composition may be configured to be applied as a liquid which hardens into a solid after being applied and forms the potting compound 56. In some embodiments the potting composition may be reactive such that the potting composition is applied as a liquid that flows around the electric cells 52 and through the gap 80 defined between adjacent electric cells 52 and then hardens after the completion of the reaction.

The potting composition can flow through the gap 80 between adjacent electric cells 52 and settle at a level height around the electric cells 52 and in the gap 80 or spaces defined between the electric cells 52. For example, referring to FIG. 3, the potting composition may be poured into the battery case 54 having the electric cells 52 arranged within. The liquid potting composition has sufficient flowability before curing to permit the liquid potting composition to flow through the spaces defined by the gap 80 between the adjacent electric cells 52 and/or between an electric cell and the battery case 54. The liquid potting composition has sufficient flowability to settle at a substantially level height before curing to form the potting compound.

As used herein flowability refers to the ease with which a substance will move under a certain set of conditions. Some of these conditions may include the temperature of the substance, the viscosity of the substance, or the size of the space through which the substance can flow through For example, for the potting composition that is a liquid, the flowability of the liquid governs how it will behave when poured and how well it flows between adjacent electric cells and/or the between an electric cell and the battery case. In some embodiments, the potting composition is self-leveling.

In a preferred embodiment, the potting composition has sufficient flowability such that the potting composition can be poured around an electric cell, or the electric cells 52, and settles at a substantially level height around the electric cell or electric cells 52 before the potting composition hardens to form the potting compound 56. For example, the potting composition has sufficient flowability such that after the potting composition has been poured into a container such as the battery case 54, the potting composition can flow around objects, such as electric cells 52, in the container the potting composition and can disperse and level to a height 86 before curing to form the potting compound, and that height is substantially the same when the height 86 is measured at any two or more locations in the container around the electric cells 52 (e.g. throughout the battery case 54). The potting composition has sufficient flowability to disperse such that the potting composition can flow around objects before curing to form the potting compound, and after the potting composition has cured, the potting compound has a height 86 that is substantially the same when the height is measured at various locations around the electric cells 52 (e.g., throughout the battery case 54).

Having a potting composition having sufficient flowability to form a substantially level height can help form a potting compound that encapsulates each of the electric cells at substantially the same height. This provides a consistent amount of encapsulation around each of the electric cells. This may ensure suitable encapsulation of the electric cells 52 to ensure suitable level of protection, such as a suitable amount of structural stability and/or a suitable amount of flame retardant to contain a fire or flames. Having a potting compound having a substantially level height may help the weight of the battery module 50 to be balanced throughout the battery module 50. Suitable balance, or weight distribution, helps the battery module 50 to remain stable, for example when used in a moving vehicle. A suitably balanced battery module may be preferred for use in a vehicle, as it may have less of a tendency to rock or tilt in response to external forces, such as side to side, or front to back, acceleration.

Having a battery module that is low weight may be preferred, as this may make the battery module more portable, and may reduce the amount of energy required to move the battery module. For example, in an electric vehicle, it may be advantageous to have a lighter battery module that can produce the same amount of power as a heavier embodiment. One option for accomplishing this may be to use the same type and number of electric cells but reduce the weight of other components Reducing the density of the potting compound may help to reduce the overall weight of the potting compound, without reducing other desirable qualities Having the flame retardant component also helps reduce the likelihood of an uncontrolled fire from the battery module

After being fully cured, the potting compound, may have elasticity and help to buffer shock or vibrations imparted to the battery module when the battery module is in use. This may help prevent safety problems caused by collision among the electric cells, and/or detachment of the electric cells from the wires.

The cured potting compound may have a certain degree of porosity, controlled such that if one electric cell is involved in a safety problem and leaks, any leaking material such as fluid or gas will be contained and isolated by the potting compound positioned among the adjacent electric cells, to help improve the safety performance of the battery module. In addition, the battery module has the advantages of simple structure, low density, small size, and low cost.

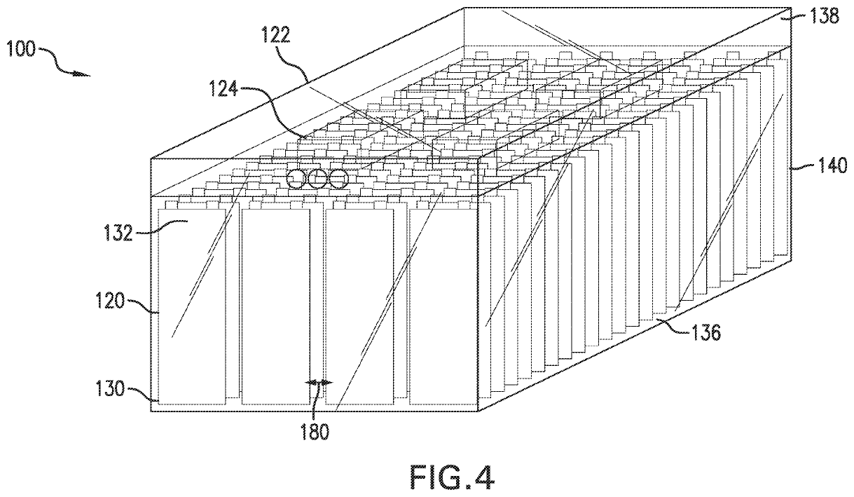

FIG. 4 is a perspective view of an example battery module 100. As shown in FIG. 4, the battery module 100 includes an electric cell 120 and a battery case 122 In some embodiments, the battery module 100 includes more than one electric cell 120. The electric cell 120 may be any suitable shape which generally bas a bottom 130, a top 132 and a length defined therebetween. The battery case 122 may be any suitable shape for positioning the electric cell 120 within the battery case 122. The battery case 122 may be any suitable three dimensional shape which generally has a bottom 136, a top 138, and a wall 140 defined therebetween. The bottom 136 of the battery case 122 defines an inner surface and an outer surface; the wall 140 of the battery case 122 defines an inner surface and an outer surface. The battery case 122 defines an enclosed space having an internal volume.

As shown, the electric cell 120 may be positioned within the battery case 122. As also shown, the electric cell 120 is associated with a potting compound 124. The potting compound 124 is positioned within the battery case 122 and occupies a portion of the internal volume of the battery case 122.

In some embodiments, the battery case 122 forms an enclosed space that surrounds the electric cell 120 and other components such as wires, terminals, or connections. The enclosed space defines the internal volume of the battery case 122. The top 138 of the battery case 122, may define an opening. The top 138 may be shaped and sized to receive a cover that can be closed to separate the internal volume of the enclosed space from the outside of the battery case 122. The battery case 122 may be configured to provide mechanical or structural support to the electric cell 120. The battery case 122 may be configured to provide protection from potential damage to the electric cell 120, e.g. moisture, heat, cold, chemicals, shock, vibration, puncturing, or flames. In some embodiments, the battery case 122 may be configured to receive the potting compound 124 relative to the electric cell 120, including e.g., below an electric cell 120, between a first and an adjacent electric cell 120, above an electric cell 120, or between the electric cell 120 and the wall 140 of the battery case.

In some embodiments, a process for positioning the potting compound 124 in relation to the electric cell 120 includes first positioning the electric cell 120 inside the battery case 122. One or more electric cells 120 can be positioned together in the battery case with a gap 180 defined between adjacent electric cells 120. In some embodiments, a gap 180 may also be defined between the electric cell 120 and the wall 140 of the battery case 122. In some examples, the potting compound 124 can be prepared in a separate container and then poured into the battery case 122. The components of the potting compound 124 can be mixed to form a composition that is curable to form a foam, and then the composition can be poured into the battery case 122 and allowed to flow throughout the battery case 122 between the electric cells 120. For example, the components of the potting compound 124 can be mixed to form a composition that is curable to form a foam, and then the foam can applied to the top 132 of the electric cell 120. The potting compound 124 can be added such that a layer of potting compound 124 having a thickness is disposed over the top 132 of the electric cell 120. In some embodiments, the potting compound 124 can be positioned in the gap 180 between adjacent electric cells 120. The potting compound 124 can be positioned in the gap 180 between the wall 120 and the electric cell 120. The potting compound 124 can be positioned such that a space is defined between the top of the potting compound 124 and the top 138 of the battery case 122 In some embodiments, an amount of potting compound 124 can be cured into a suitable preformed shape, and the preformed shape can be added into the battery case 122 in a suitable position relative to the electric cell 120.

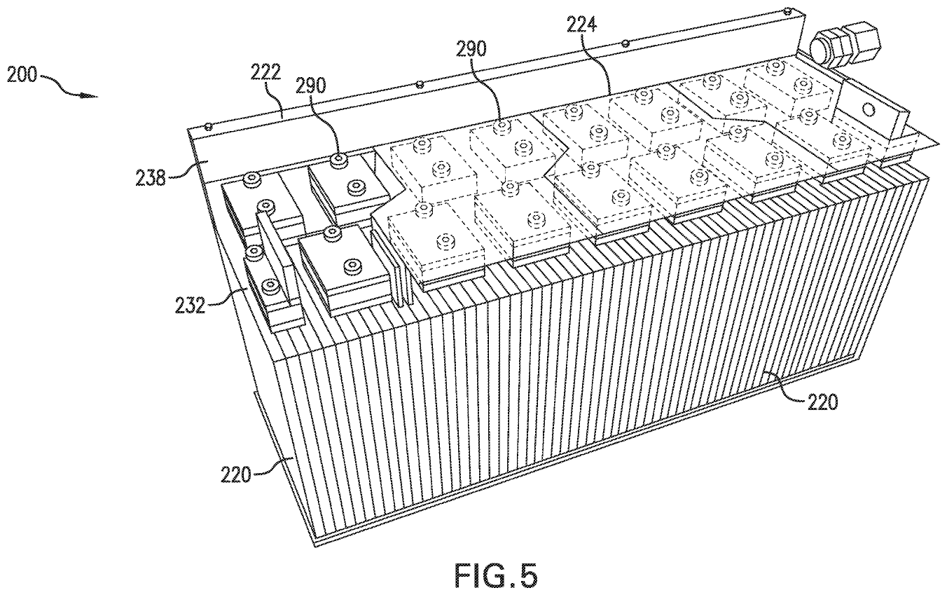

FIG. 5 is a top view of an example battery module 200. The battery module 200 includes electric cells 220 positioned adjacent to one another. As shown in FIG. 5, the electric cells 220 are positioned within a battery case 222 that has a top 238. The battery case 222 defines an internal volume. As shown, the battery case 222 is sized such that the electric cells 222 can be positioned within the internal volume of the battery case 222 with a space between the top 232 of the battery case 222 and the top 232 of the electric cells 220. Also shown is a potting compound 224 positioned within the internal volume of the battery case 222. As shown, the potting compound 224 has a generally planar shape and extends along the top 232 of the electric cells 220. The potting compound 224 can be configured such that the terminals 290 of the electric cells 220 are accessible to a user. In some embodiments, the electric cells 220 include terminals 290 positioned on a top 232 of the electric cells 220. The potting compound 224 can be positioned around the terminals 290 and between the top 232 of the electric cells 220 and the top 238 of the battery case 222.

In some embodiments, a process for positioning the potting compound 224 in relation to the electric cells 220 includes first positioning the electric cells 220 inside the battery case 222. The potting compound 224 can be prepared in a separate container and then poured into the battery case 222. A suitable amount of potting compound 224 can be added such that a layer of potting compound 224 having a thickness is disposed at least one of over the top 232 of the electric cells 220 or in between adjacent electric cells 220. In some embodiments, the potting compound 224 can be added such that the layer of potting compound 224 has a thickness suitable to cover the tops 232 of the electric cells 220 with the terminals 290 protruding through the thickness of the potting compound 224. The potting compound can maintain the electric cells 220 in spatial relationship with each other, e.g. by holding the electric cells 220 in relation to each other such as by potting or encapsulating the terminals 290.

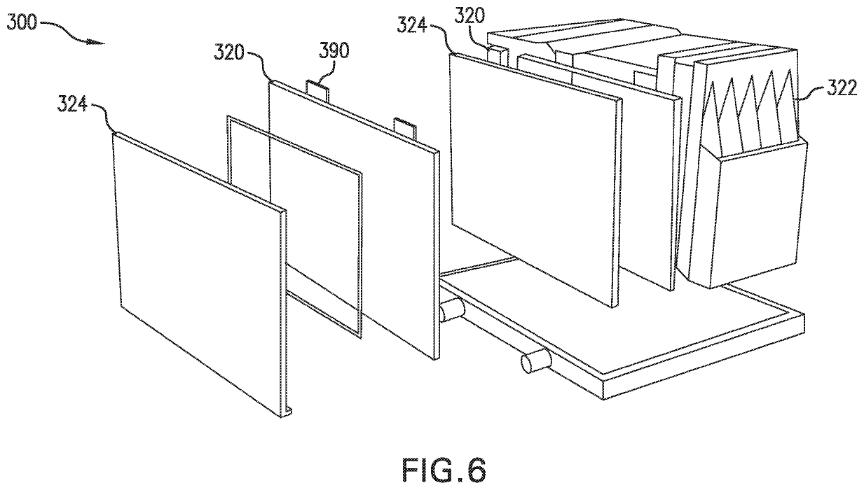

FIG. 6 is an exploded view of an example battery module 300. The battery module 300 includes electric cells 320 positioned adjacent to one another. In some embodiments, the battery module 300 includes a battery case 322. The electric cells 220 are shown with terminals 290 positioned on a top 232 of the electric cells 220. Also shown is a potting compound 324 associated with the electric cells 320. As shown in FIG. 6, the electric cells 320 can have a generally planar shape. As shown, a section of the potting compound 224 has a generally planar shape. In some configurations, a section of potting compound 324 can be positioned in between adjacent electric cells 320. For example, a section of potting compound 324 can have a planar shape and be positioned parallel to the plane of the electric cells 320.

In some embodiments, a process for positioning the potting compound 324 in relation to the electric cells 320 includes first positioning the electric cells 320 in spatial relationship to one another and then the potting compound 324 can be positioned into a space defined between adjacent electric cells 320. For example, the potting compound 324 can be poured into and cure in the space between adjacent electric cells 320. As a further example, the potting compound 324 can be cured and formed into a preformed section which can then be positioned in the space between adjacent electric cells 320. A suitable amount of potting compound 324 can be provided such that a section of potting compound 324 having a suitable thickness is disposed between adjacent electric cells 220. In some embodiments, a section of potting compound 224 can be provided such that the section of potting compound 324 has a thickness suitable to provide a suitable level of flame resistance. In some embodiments, the potting compound 320 can maintain the electric cells 320 in spatial relationship with each other, e.g., absorbing shock or vibration of the battery module 300.

### EXAMPLES

The following non-limiting examples are included to further illustrate various embodiments of the instant disclosure and do not limit the scope of the instant disclosure.

### Test Methods:

### Viscosity Test

The viscosity is measured with a Brookfield Viscometer model RVF (from AMETEK Brookfield of Middleboro, MA), at a spindle speed of 50 rpm and at an ambient temperature of 25° C. (77°±2° F.). The spindle used is a number 1 (up to 200 cps), number 2 (up to 800 cps), number 3 (up to 2,000 cps), or number 4 (up to 4,000 cps) depending on the composition being tested.

### Foam Density Test

The weight of an empty measuring device is recorded to within 0.1 gram. The maximum volume of the measuring device is measured by filling the measuring device with water and recording the amount of water needed to fill the internal volume of the measuring device in milliliters.

The components of the composition to be measured are weighed and added to the measuring device. The components are mixed vigorously for 15 to 20 seconds. The sides and bottom of the measuring device are thoroughly scraped to ensure all the components are incorporated. The measuring device is sharply tapped on a hard surface to level the composition. The measuring device is placed on a level surface and the composition is allowed to react and the resulting foam is allowed to freely rise undisturbed. The foam is allowed to set for 60 to 70 minutes. After curing, the top of the foam bun extending above the top of the measuring device is cut to be level with the top of the measuring device using a flat cutting tool, such as a knife or saw.

The measuring device containing the remaining cured composition is weighed, the weight in grams is recorded. The weight of the empty measuring device is subtracted from the weight of the measuring device containing the cured composition to obtain the weight of the cured composition. The density is calculated by dividing the weight of the cured composition by the volume of the measuring device.

The Free Rise Density is the density of the portion of the cured composition that remains in the measuring device containing the cured composition after the top of the foam bun extending above the top of the measuring device is cut.

### Start of Rise Time Test

The Start of Rise Time Test is carried out by positioning all of the components that form the composition to be measured into a container for mixing the composition. Once all the components of the composition to be measured have been positioned in the mixing container, the timer is started, and the components are mixed together.

Once the components of the composition to be measured have been mixed together, the composition is positioned in a measuring container and the height of the top surface of the composition in the measuring container is marked on the side of the container. The time when the top surface of the composition begins to rise from the marked starting height under the foaming action of the chemical reaction of the components is the end of the test.

### Top of Cup Time Test

The Top of Cup Time Test is carried out by positioning all of the components that form the composition to be measured into a container for mixing the composition. Once all the components of the composition to be measured have been positioned in the mixing container, the timer is started, and the components are mixed together.

Once the components of the composition to be measured have been mixed together, the composition is positioned in a measuring container and a measuring stick (e.g., a tongue depressor) is placed across the top surface of the measuring container. The time when the composition to be measured rises under the foaming action of the chemical reaction of the components and touches the measuring stick is the end of the test.

### Burn Test

The Burn Test is conducted in accordance with the UL 94 Test for Flammability of Plastic, Vertical Burning Test method. Burn Test sample strips are prepared by pouring the composition to be tested into a mold having the following dimensions. 150 mm long by 13 mm wide and having a thickness to be tested (1.0 mm, 1.6 mm, 3.2 mm, 6.35 mm, or 9.5 mm). The sample to be tested is allowed to cure in the mold for from eight to 20 hours before being removed. After being formed, the strips of sample to be tested are conditioned at an ambient temperature of 25±2° C. and 50±5% RH for a minimum of 48 hours before being tested.

A layer of cotton is positioned below a Bunsen burner, to catch possible drippings from the sample to be tested. The Bunsen burner is set with a flame length of about 2.5 cm (about one inch). The strip of sample to be tested is hung vertically over the Bunsen burner for 10 seconds a first time. The flame is then removed, and the strip of sample is allowed to self-extinguish. The flame is then re-applied to the sample a second time, also for 10 seconds, and removed once again to allow the strip of sample to self-extinguish a second time. The amount of time from when the sample is removed from the flame until the sample self-extinguishes is measured.

The sum of the amount of time of both the first and second instances the sample needs in order to self-extinguish is used to determining the sample's V rating. Any ignition of the cotton layer positioned below the sample is used to determine the V rating, in combination with the self-extinguishing time.

The material is rated V0 if an individual strip of sample self-extinguished no greater than 10 seconds after the strip of sample is removed from the flame of the burner, the total self-extinguishing time for a set of five specimens is less than 50 seconds, and there is no ignition of the cotton layer positioned under the Bunsen burner.

The material is rated V1 if an individual strip of sample self-extinguished no greater than 30 seconds after the strip of sample is removed from the flame of the burner, the total self-extinguishing time for a set of five specimens is less than 250 seconds, and there is no ignition of the cotton layer positioned under the Bunsen burner

The material is rated V2 if an individual strip of sample self-extinguished no greater than 30 seconds after the strip of sample is removed from the flame of the burner, and the total self-extinguishing time for a set of five specimens is less than 250 seconds, but the cotton indicator was ignited by particles emitted from the strip of sample.

### Foam Core Integrity Test

The Foam Core Integrity Test is carried out on samples that have been subjected to the Burn Test. Each sample that has been subjected to the Burn Test is allowed to cool and then lightly touched to remove any surface char and any part of the sample that is not intact. The strip of sample should be handled gently to prevent damaging the strip. The length of the portion of each sample that has been burned is measured with a ruler on a flat surface and recorded.

### Foam Integrity Test

Strips of sample for carrying out the Foam Integrity Test are created using the sample preparation steps described in the Burn Test.

A Foam Integrity Test can be carried out on a sample after it has been subjected to the Burn Test. Samples having been subjected to the Burn Test are conditioned at a temperature of 25=2° C. and 50±5% RH for 24 hours after the Burn Test has been completed.

Samples have been subjected to the Burn Test are visually inspected to determine the portion of the strip of sample that has been burned during the Burn Test and the portion that has not been burned. The strips of sample are measured using an Instron 5967 (from Instron, Corp. of Norwood, MA) using a 1.5 inch diameter head. The Instron head is compressed into the portion of the strip of sample that is not burned, at a speed of 0.127 cm/min (0.05 inches/min) and stopped when the Instron head has traveled about 50% of the distance through the total thickness of the strip of sample. The Instron head is then compressed into the portion of the strip that has been burned, at a speed of 0.127 cm/min (0.05 inches/min) and stopped when the Instron head has traveled about 50% of the distance through the total thickness of the strip of sample

The burned portion of the strip and the unburned portion of the strip are measured. The Instron provides a measured value of the modulus of the strip of sample.

### Self-Leveling Test

The Self-Leveling Test can be used to determine a composition that forms a substantially level height.

A composition to be tested is prepared as described in the Foam Density Test. After being mixed, the composition to be tested is poured into a container, such as the battery case 54, that contains objects, such as the electric cells 52, that the composition to be tested is allowed to flow between. The size of each gap 80 between adjacent electric cells 52 is from about one mm to about three mm wide.

To determine a substantially level height, the height 86 of the potting compound 56 is measured from the bottom 82 of the potting compound 56 to the top 84 of the potting compound 56. The height 86 is measured at two or more locations of the potting compound 56. For example, a measurement can be taken near the wall of the battery case 54 and another measurement taken near the center of the battery case 54 (such as equidistant from two opposing sides of the case). A potting compound has a substantially level height if measurements of the height of the potting compound taken at any two or more locations are within 20 percent of one another.

Additionally, or alternatively, if the electric cells 52 are the same length, and are positioned the same distance from the bottom and/or top of the battery case 54, the potting compound 56 is at a substantially level height if each of the measurements of distance of the potting compound 56 along the length of each of the electric cells 52 are within 20 percent of one another.

### Preparation

An example process for forming the sample compositions and compounds to be tested is described. This same process was used for all the sample compositions, with the amounts of each component listed in Tables 1 and 2 below.

### First and Second Component Forming Process

To form the first component, a liquid polyol is first added to a mixing vessel. The mixer speed is between 25 and 30 rpms as the liquid polyol is being added. The mixer speed is increased to between 600 and 800 rpms once all the liquid polyol was added.

In samples compositions where they are included, a liquid glycerin, a triethanolamine, a polyether, and an antisettling agent are then added to the mixing vessel. In samples where they are included, a thixotrop (fumed silica), a nucleating agent, and a liquid first flame retardant component are then added to the mixing vessel. The contents of the mixing vessel are mixed from about 15 to about 20 minutes.

Distilled water is then added to the mixing vessel. In samples where they are included, while the contents of the mixing vessel are being mixed, a catalyst and surfactant are added. In samples where it is included, a second flame retardant is then added. The contents of the mixing vessel are mixed for about 30 minutes to form the first component. After about 30 minutes, the mixing is stopped, and the first component is emptied from the mixing vessel.

To form the second component, a liquid isocyanate is added to a mixing vessel. The liquid isocyanate is mixed at a mixer speed from 25 to 30 rpms while being added to the mixing vessel. In samples having a first or second flame retardant included in the second component, the first and/or second flame retardant is then added to the mixing vessel. The contents of the mixing vessel are mixed for 15 to 20 minutes to form the second component. After 15 to 20 minutes, the mixing is stopped, and the second component is emptied from the mixing vessel

### Potting Composition and Potting Compound Forming Process

Suitable portions of the First Component and Second Component are poured into a mixing container.

The higher density component is placed into the mixing container first and then the second component is gently added on top of the first component. This process can help limit pre-reaction of the materials at the interface. The sides and bottom of the individual measuring containers are scraped to ensure as much of the measured materials are added to the mixing container.

A timer is started, and the contents of the mixing container are vigorously mixed for 20 to 30 seconds with a flat sided stir utensil until the mixture is homogeneous and uniform in appearance. The sides and bottom of the mixing container are scraped during the mixing. After mixing, the contents of the mixing container are immediately poured into a mold.

### Sample Compositions

Sample compositions were made by forming a First Component (Part A) and a Second Component (Part B) separately. The composition of Part A of each sample composition is shown in Table 1, and the composition of Part B of each sample composition is shown in Table 2. Components used to form the sample compositions are included here, with trade designation, and supplier where applicable.

Blowing agent (distilled water).

Liquid Phenolic Antioxidant (BNX 1035, from Mayzo, Inc., of Suwanee, GA, USA).

Glycerin 99.5% (triol crosslinker/humectant) (from the Dow Chemical Company, of Midland, MI, USA).

Cationic Polymeric Dispersant (ZEPHRYM PD-7000, from Croda International, of Snaith, England).

Thixotrop (fumed silica) (AEROSIL 200, from Evonik Industries, of Essen, Germany).

Zinc stearate (nucleating agent) (NB-60, from PMC Group, of Memphis, TN, USA).

Brominated flame retardant (ethylenebistetrabromophthalimide) (SAYTEX BT-93, from Albemarle Corporation, of Baton Rouge, LA, USA).

Low viscosity polyol (700 Mₙ PPG triol polyol) (ARCOL LHT-240 (available from Covestro AG, of Leverkusen, Germany).

5800 M. SAN grafted polyether triol polyol (VORALUX HL 431, from The Dow Chemical Company).

Silicone surfactant (foam cell surfactant) (VORASURF DC 5160, from The Dow Chemical Company).

First FR Synergist (FIREBLEND AF-100, from The St. Louis Group of Indianapolis, IN, USA).

Second FR Synergist (ADINS FIREPROOF 20, from Tolsa SA, of Madrid, Spain).

280 Mₙ PPG Tetra Polyol (amine polyol) (PLURACOL PEP 450, from BASF of Ludwigshafen, Germany).

First Tertiary Amine Catalyst 1,4-Diazabicyclo[2 2.2]octane solution (DABCO 33 LV, from Evonik Industries, of Essen, Germany).

Second tertiary amine catalyst (JEFFCAT DMDEE, from Huntsman Corporation, of The Woodlands, TX).

Amine Catalyst (DABCO DC SLE, from Evonik Industries).

Polymeric MDI—2.7 Functionality (RUBINATE M, from Huntsman Corporation).

Modified liquid MDI (isocyanate—29% NCO) (ISONATE 143L, from The Dow Chemical Company).

Halogenated phosphate ester flame retardant (FYROL PCF, from ICL Industrial Products, of St. Louis, MO, USA).

Expandable Graphite (non-halogenated fire retardant) (GRAFGUARD, from NeoGraf Solutions, LLC, of Lakewood, OH, USA).

Non-halogenated phosphate ester flame retardant (FYROLFLEX RDP, from ICL Industrial Products).

Flame Retardant Plasticizer (butylated triphenyl phosphate ester) (PHOSFLEX 71B, from ICL Industrial Products).

Non-halogenated phosphorus-based flame retardant (FYROL A710, from ICL Industrial Products).

Brominated flame retardant (ethylenebistetrabromophthalimide) (SAYTEX BT-93, from Albemarle Corporation, of Baton Rouge, LA, USA).

Phosphorous flame retardant (isopropylated triaryl phosphate ester) (REOFOS 35, from Lanxess Aktiengesellschaft, of Cologne, Germany).

Flame retardant (cresyl diphenyl phosphate) (KRONITEX CDP, from Lanxess Aktiengesellschaft).

Flame retardant (zinc borate-based flame retardant/smoke suppressant) (ZB-467, from Lanxess Aktiengesellschaft).

Flame retardant performance enhancer (antimony trioxide) (AMSPEC SELECT, from Amspec Chemical Corporation, of Gloucester City, NJ).

Red phosphorus flame retardant available under the trade designation EXOLET RP 607 (from Clariant AG, of Muttenz, Switzerland)

Ammonium polyphosphate available under the trade designation EXOLET AP 423 or aluminum diethylphosphinate available under the trade designation EXOLIT OP 945 (both from Clariant)

Melamine polyphosphate available under the trade designation MELAPURE 200 (from BASF, of Ludwigshafen, Germany).

Pentaerythritol available under the trade designation CHARMORE PT40 (from Perastorp AB, of Malmö, Sweden).

Flame retardant enhancers available under the trade designation FIREBLEND AF-100 (from The St. Louis Group of Indianapolis, IN, USA) and ADINS FIREPROOF 20 (from Tolsa SA, of Madrid, Spain).

TABLE 1
Part A - Polyol

| | Amount per Sample (by weight % of Part A) | | | | |
|---|---|---|---|---|---|
| Component | Sample 1 | Sample 2 | Sample 3 | Sample 4 | Sample 5 |
| Liquid Phenolic | 0.2 | 0.2 | 0.2 | 0.2 | 0.2 |
| Antioxidant | | | | | |
| Glycerin 99.5% | 6.75 | 6.75 | 6.75 | 6.75 | 6.75 |
| Cationic Polymeric | 0.8 | 0.8 | 0.8 | | |
| Dispersant | | | | | |
| Fumed Silica | 1 | 1 | 1 | 1 | 1 |
| Zinc Stearate | 0.7 | 0.7 | 0.7 | 0.7 | 0.7 |
| Distilled Water | 0.9 | 0.9 | 0.9 | 0.9 | 0.9 |
| 700 Mn PPG Triol Polyol | 22.64 | 22.64 | 22.64 | 22.67 | 22.67 |
| 5800 Mn SAN Grafted | 12.5 | 12.5 | 12.5 | 12.5 | 12.5 |
| Polyether Triol Polyol | | | | | |
| Silicone Surfactant | 0.5 | 0.5 | 0.5 | 0.5 | 0.5 |
| First FR Synergist | 1 | 1 | 1 | 1 | 1 |
| Second FR Synergist | | | | | |
| 280 Mn PPG Tetra Polyol | | | | | |
| First Tertiary Amine | 0.02 | 0.02 | 0.02 | 0.02 | 0.02 |
| Catalyst | | | | | |
| Second Tertiary Amine | 0.01 | 0.01 | 0.01 | 0.01 | 0.01 |
| Catalyst | | | | | |
| Amine Catalyst | 0.25 | 0.25 | 0.25 | 0.25 | 0.25 |
| FYROL PCF - ICL | | | | 53.5 | |
| FYROFLEX RDP | 45.73 | 45.73 | | | |
| Fyrolflex RDP - ICL | | | | | |
| PHOSFLEX 71B Phosflex | | | 45.73 | | 53.5 |
| 71B - ICL | | | | | |
| FYROL A710 Fyrol A710 - | | | | | |
| ICL | | | | | |
| Expandable Graphite FR | 7 | 7 | 7 | | |
| Red Phosphorus | | | | | |
| Aluminum Diethyl | | | | | |
| Phosphinate | | | | | |
| Melamine Polyphosphate | | | | | |
| Pentaerythritol | | | | | |
| | Amount per Sample (by weight % of Part A) | | | | |
| Component | Sample 6 | Sample 7 | Sample 8 | Sample 9 | Sample 10 |
| Liquid Phenolic | 0.2 | 0.2 | 0.2 | | 0.2 |
| Antioxidant | | | | | |
| Glycerin 99.5% | 6.75 | 6.75 | 6.75 | 5.5 | 6.75 |
| Cationic Polymeric | | | 0.8 | | 0.8 |
| Dispersant | | | | | |
| Fumed Silica | 1 | 1 | | 1 | |
| Zinc Stearate | 0.7 | 0.7 | | 0.74 | |
| Distilled Water | 0.9 | 0.9 | 0.9 | 0.9 | 0.9 |
| 700 Mn PPG Triol Polyol | 22.67 | 22.67 | 22.7 | 22.56 | 22.7 |
| 5800 Mn SAN Grafted | 12.5 | 12.5 | 12.5 | 12.5 | 12.5 |
| Polyether Triol Polyol | | | | | |
| Silicone Surfactant | 0.5 | 0.5 | 0.5 | 0.5 | 0.5 |
| First FR Synergist | 1 | 1 | | 1 | |
| Second FR Synergist | | | 2.7 | | 2.7 |
| 280 Mn PPG Tetra Polyol | | | | 4.1 | |
| First Tertiary Amine | 0.02 | 0.02 | | 0.02 | |
| Catalyst | | | | | |
| Second Tertiary Amine | 0.01 | 0.01 | | 0.01 | |
| Catalyst | | | | | |
| Amine Catalyst | 0.25 | 0.25 | | 0.17 | |
| FYROL PCF - ICL | | | | 49 | |
| FYROFLEX RDP | 53.5 | | | | |
| Fyrolflex RDP - ICL | | | | | |
| PHOSFLEX 71B Phosflex | | | | | |
| 71B - ICL | | | | | |
| FYROL A710 Fyrol A710 | | 53.5 | 45.5 | | 45.5 |
| - ICL | | | | | |
| Expandable Graphite FR | | | 7.45 | | |
| Red Phosphorus | | | | 2 | 7.45 |
| Aluminum Diethyl | | | | | |
| Phosphinate | | | | | |
| Melamine Polyphosphate | | | | | |
| Pentaerythritol | | | | | |
| | Amount per Sample (by weight % of Part A) | | | | |
| Component | Sample 11 | Sample 12 | Sample 13 | Sample 14 | Sample 15 |
| Liquid Phenolic | 0.2 | 0.2 | 0.2 | 0.2 | 0.2 |
| Antioxidant | | | | | |
| Glycerin 99.5% | 6.75 | 6.75 | 6.75 | 6.75 | 6.75 |
| Cationic Polymeric | 0.8 | 0.8 | 0.8 | 0.8 | 0.8 |
| Dispersant | | | | | |
| Fumed Silica | | | | | |
| Zinc Stearate | | | | | |
| Distilled Water | 0.9 | 0.9 | 0.9 | 0.9 | 0.9 |
| 700 Mn PPG Triol Polyol | 22.65 | 22.7 | 22.7 | 22.7 | 22.7 |
| 5800 Mn SAN Grafted | 12.5 | 12.5 | 12.5 | 12.5 | 12.5 |
| Polyether Triol Polyol | | | | | |
| Silicone Surfactant | 0.5 | 0.5 | 0.5 | 0.5 | 0.5 |
| First FR Synergist | | | | | |
| Second FR Synergist | 2.7 | 2.7 | 2.7 | 2.7 | 2.7 |
| 280 Mn PPG Tetra Polyol | | | | | |
| First Tertiary Amine | | | | | |
| Catalyst | | | | | |
| Second Tertiary Amine | | | | | |
| Catalyst | | | | | |
| Amine Catalyst | | | | | |
| FYROL PCF - ICL | | | | | |
| FYROFLEX RDP | | | | | |
| Fyrolflex RDP - ICL | | | | | |
| PHOSFLEX 71B Phosflex | | | | | |
| 71B - ICL | | | | | |
| FYROL A710 Fyrol A710 | 45 | 52.95 | 50.95 | 48.95 | 46.95 |
| ~ ICL | | | | | |
| Expandable Graphite FR | | 0 | 2 | 4 | 6 |
| Red Phosphorus | | | | | |
| Aluminum Diethyl | 4.8 | | | | |
| Phosphinate | | | | | |
| Melamine Polyphosphate | 1.84 | | | | |
| Pentaerythritol | 1.36 | | | | |

| | Amount per Sample (by weight % of Part A) | |
|---|---|---|
| Component | Sample 16 | Sample 17 |
| Liquid Phenolic Antioxidant | 0.2 | 0.2 |
| Glycerin 99.5% | 6.75 | 6.75 |
| Cationic Polymeric Dispersant | 0.8 | 0.8 |
| Fumed Silica | | |
| Zinc Stearate | | |
| Distilled Water | 0.9 | 0.9 |
| 700 Mn PPG Triol Polyol | 22.7 | 22.7 |
| 5800 Mn SAN Grafted Polyether Triol | 12.5 | 12.5 |
| Polyol | | |
| Silicone Surfactant | 0.5 | 0.5 |
| First FR Synergist | | |
| Second FR Synergist | 2.7 | 2.7 |
| 280 Mn PPG Tetra Polyol | | |
| First Tertiary Amine Catalyst | | |
| Second Tertiary Amine Catalyst | | |
| Amine Catalyst | | |
| FYROL PCF - ICL | | |
| FYROFLEX RDP Fyrolflex RDP - ICL | | |
| PHOSFLEX 71B Phosflex 71B - ICL | | |
| FYROL A710 Fyrol A710 - ICL | 44.95 | 42.95 |
| Expandable Graphite FR | 8 | 10 |
| Red Phosphorus | | |
| Aluminum Diethyl Phosphinate | | |
| Melamine Polyphosphate | | |
| Pentaerythritol | | |

TABLE 2
Part B - Isocyanate

| | Amount per Sample (by weight % of Part B) | | | | |
|---|---|---|---|---|---|
| Component | Sample 1 | Sample 2 | Sample 3 | Sample 4 | Sample 5 |
| Polymeric MDI - 2.7 | 61 | 61 | 61 | 61 | 61 |
| Functionality | | | | | |
| Fyrol PCF - ICL | 39 | | | 29.5 | |
| Fyrolflex RDP - ICL | | 39 | | | |
| Phosflex 71B - ICL | | | 39 | | 29.5 |
| Fyrol A710 - ICL | | | | | |
| Expandable Graphite FR | | | | 8.7 | 8.7 |
| Cationic Polymeric | | | | 0.8 | 0.8 |
| Dispersant | | | | | |
| First Tertiary Amine | | | | | |
| Catalyst | | | | | |
| Second Tertiary Amine | | | | | |
| Catalyst | | | | | |
| Amine Catalyst | | | | | |
| | Amount per Sample (by weight % of Part B) | | | | |
| Component | Sample 6 | Sample 7 | Sample 8 | Sample 9 | Sample 10 |
| Polymeric MDI - 2.7 | 61 | 61 | 61 | 61 | 61 |
| Functionality | | | | | |
| Fyrol PCF - ICL | | | | 39 | |
| Fyrolflex RDP - ICL | 29.5 | | | | |
| Phosflex 71B - ICL | | | | | |
| Fyrol A710 - ICL | | 29.5 | 38.78 | | 38.78 |
| Expandable Graphite | 8.7 | 8.7 | | | |
| FR | | | | | |
| Cationic Polymeric | 0.8 | 0.8 | | | |
| Dispersant | | | | | |
| First Tertiary Amine | | | 0.01 | | 0.01 |
| Catalyst | | | | | |
| Second Tertiary Amine | | | 0.01 | | 0.01 |
| Catalyst | | | | | |
| Amine Catalyst | | | 0.2 | | 0.2 |
| | Amount per Sample (by weight % of Part B) | | | | |
| Component | Sample 11 | Sample 12 | Sample 13 | Sample 14 | Sample 15 |
| Polymeric MDI - 2.7 | 61 | 61 | 6 | 61 | 61 |
| Functionality | | | | | |
| Fyrol PCF - ICL | | | | | |
| Fyrolflex RDP - ICL | | | | | |
| Phosflex 71B - ICL | | | | | |
| Fyrol A710 - ICL | 38.78 | 38.78 | 38.78 | 38.78 | 38.78 |
| Expandable Graphite | | | | | |
| FR | | | | | |
| Cationic Polymeric | | | | | |
| Dispersant | | | | | |
| First Tertiary Amine | 0.01 | 0.01 | 0.01 | 0.01 | 0.01 |
| Catalyst | | | | | |
| Second Tertiary Amine | 0.01 | 0.01 | 0.01 | 0.01 | 0.01 |
| Catalyst | | | | | |
| Amine Catalyst | 0.2 | 0.2 | 0.2 | 0.2 | 0.2 |

| | Amount per Sample (by weight % of Part B) | |
|---|---|---|
| Component | Sample 16 | Sample 17 |
| Polymeric MDI - 2.7 Functionality | 61 | 61 |
| Fyrol PCF - ICL | | |
| Fyrolflex RDP - ICL | | |
| Phosflex 71B - ICL | | |
| Fyrol A710 - ICL | 38.78 | 38.78 |
| Expandable Graphite FR | | |
| Cationic Polymeric Dispersant | | |
| First Tertiary Amine Catalyst | 0.01 | 0.01 |
| Second Tertiary Amine Catalyst | 0.01 | 0.01 |
| Amine Catalyst | 0.2 | 0.2 |

The final composition of each sample composition was formed by mixing Part A of each sample with Part B at a weight ratio of 100 to 86 for every sample. The sample compositions were tested according to the test methods described above. The results and observations are set forth in Table 3.

TABLE 3
Sample Compositions and Results

| | Sample 1 | Sample 2 | Sample 3 | Sample 4 | Sample 5 |
|---|---|---|---|---|---|
| Viscosity part A @ 25C (cps) | 2700 | 2320 | 1160 | 496 | 520 |
| Density part A | 10.03 | 9.76 | 9.58 | 10.03 | 9.51 |
| Viscosity part B @ 25C (cps) | 180 | 320 | 120 | 368 | 260 |
| Density part B (cps) | 10.56 | 10.58 | 10.09 | 10.55 | 10.33 |
| Mixed Viscosity at 30 seconds | 560 | 920 | 480 | 560 | 340 |
| Mixed Viscosity at 60 seconds | 560 | 920 | 480 | 664 | 340 |
| Mixed Viscosity at 120 seconds | 600 | 960 | 480 | 760 | 380 |
| Mixed Viscosity at 150 seconds | 660 | 1040 | 480 | 780 | 520 |
| Mixed Viscosity at 180 seconds | 920 | 1400 | 680 | 860 | 1120 |
| Mixed Viscosity at 210 seconds | 2320 | 2640 | 1200 | 1080 | 2400 |
| Start of Rise Time (sec.) | 170 | 180 | 190 | 185 | 184 |
| Top of Cup Time (sec.) | 305 | 407 | 365 | 379 | 312 |
| Free Rise Density (pcf) | 11.48 | 11.68 | 10.27 | 11.53 | 11.95 |
| Free Rise Density (g/cc) | 0.18 | 0.19 | 0.16 | 0.18 | 0.19 |
| | | | | | Sample |
| | Sample 6 | Sample 7 | Sample 8 | Sample 9 | 10 |
| Viscosity part A @ 25C (cps) | 1400 | 480 | 1360 | 620 | 520 |
| Density part A | 9.9 | 9.57 | 9.61 | 9.94 | 9.79 |
| Viscosity part B @ 25C (cps) | 680 | 296 | 140 | 180 | 140 |
| Density part B (cps) | 10.3 | 10 | 10.17 | 10.56 | 10.18 |
| Mixed Viscosity at 30 seconds | 960 | 352 | 520 | 560 | 280 |
| Mixed Viscosity at 60 seconds | 980 | 352 | 520 | 560 | 300 |
| Mixed Viscosity at 120 seconds | 1020 | 380 | 600 | 540 | 320 |
| Mixed Viscosity at 150 seconds | 1040 | 400 | 720 | 540 | 380 |
| Mixed Viscosity at 180 seconds | 1100 | 420 | 1120 | 540 | 520 |
| Mixed Viscosity at 210 seconds | 1220 | 480 | 2280 | 640 | 1560 |
| Start of Rise Time (sec.) | 220 | 235 | 185 | 284 | 190 |
| Top of Cup Time (sec.) | 555 | 520 | 347 | 543 | 395 |
| Free Rise Density (pcf) | 11.67 | 10.87 | 11.77 | 11.55 | 11.69 |
| Free Rise Density (g/cc) | 0.19 | 0.17 | 0.19 | 0.19 | 0.19 |

| | Sample | Sample | Sample | Sample | Sample |
|---|---|---|---|---|---|
| | 11 | 12 | 13 | 14 | 15 |
| Viscosity part A @ 25C (cps) | 1120 | 320 | 340 | 420 | 460 |
| Density part A | 9.51 | 9.54 | 9.54 | 9.68 | 9.74 |
| Viscosity part B @ 25C (cps) | 140 | 140 | 140 | 140 | 140 |
| Density part B (cps) | 10.18 | 10.17 | 10.17 | 10.17 | 10.17 |
| Mixed Viscosity at 30 seconds | 520 | 280 | 260 | 280 | 300 |
| Mixed Viscosity at 60 seconds | 520 | 280 | 260 | 280 | 300 |
| Mixed Viscosity at 120 seconds | 500 | 280 | 260 | 280 | 300 |
| Mixed Viscosity at 150 seconds | 520 | 280 | 260 | 280 | 300 |
| Mixed Viscosity at 180 seconds | 600 | 340 | 320 | 300 | 360 |
| Mixed Viscosity at 210 seconds | 920 | 660 | 460 | 480 | 540 |
| Start of Rise Time (sec.) | 233 | 206 | 202 | 195 | 204 |
| Top of Cup Time (sec.) | 528 | 395 | 381 | 347 | 334 |
| Free Rise Density (pcf) | 12.24 | 11.18 | 11.31 | 11.03 | 11.33 |
| Free Rise Density (g/cc) | 0.2 | 0.18 | 0.18 | 0.18 | 0.18 |

| | Sample 16 | Sample 17 |
|---|---|---|
| Viscosity part A @ 25C (cps) | 580 | 660 |
| Density part A | 9.84 | 10.02 |
| Viscosity part B @ 25C (cps) | 140 | 140 |
| Density part B (cps) | 10.17 | 10.17 |
| Mixed Viscosity at 30 seconds | 320 | 340 |
| Mixed Viscosity at 60 seconds | 320 | 340 |
| Mixed Viscosity at 120 seconds | 320 | 340 |
| Mixed Viscosity at 150 seconds | 320 | 340 |
| Mixed Viscosity at 180 seconds | 340 | 400 |
| Mixed Viscosity at 210 seconds | 540 | 540 |
| Start of Rise Time (sec.) | 200 | 208 |
| Top of Cup Time (sec.) | 334 | 337 |
| Free Rise Density (pcf) | 11.26 | 11.03 |
| Free Rise Density (g/cc) | 0.18 | 0.18 |

The samples compositions were formed into strips of compound; each strip was 150 mm long by 13 mm wide and a thickness of 1.0 mm, 1.6 mm, 3.2 mm, or 6.35 mm. The strips of sample composition were tested according to the Burn Test described above. The results of the burn test for each sample composition at each thickness are set forth in Table 4.

TABLE 4
UL 94 Vertical Burn Test Results Per Sample Strip Thickness

| Thickness(mm) | 6.35 | 3.2 | 1.6 | 1 |
|---|---|---|---|---|
| Sample 1 | V-0 | V-0 | V-0 | V-0 |
| Sample 2 | V-0 | V-0 | V-0 | V-0 |
| Sample 3 | V-0 | V-0 | V-0 | V-0 |
| Sample 4 | V-0 | V-0 | V-0 | V-0 |
| Sample S | V-0 | V-0 | V-0 | V-0 |
| Sample 6 | V-0 | V-0 | V-0 | V-0 |
| Sample 7 | V-0 | V-0 | V-0 | V-0 |
| Sample 8 | V-0 | V-0 | V-0 | V-0 |
| Sample 9 | V-0 | V-0 | V-2 | V-2 |
| Sample 10 | V-0 | V-0 | V-0 | V-0 |
| Sample 11 | V-0 | V-0 | V-0 | V-0 |
| Sample 12 | V-0 | V-0 | V-0 | V-1 |
| Sample 13 | V-0 | V-0 | V-0 | V-1 |
| Sample 14 | V-0 | V-0 | V-0 | V-0 |
| Sample 15 | V-0 | V-0 | V-0 | V-0 |
| Sample 16 | V-0 | V-0 | V-0 | V-0 |
| Sample 17 | V-0 | V-0 | V-0 | V-0 |

Burn Samples were made by forming strips of compound using compositions with varying amounts of graphite-based flame retardant. The Burn Samples were tested according to the Foam Core Integrity Test described above. The results and observations are set forth in Table 5.

TABLE 5
Foam Core Integrity Test Results

| | | Average of 3 repetitions | | |
|---|---|---|---|---|
| Burn | % graphite FR in | Strip Thickness | Strip Length | % |
| Sample | Burn Sample | (mm) | (mm) | remaining |
| 1 | 10% graphite FR | 3.2 | 14.3 | 96.40 |
| 2 | | 1.6 | 13.9 | 93.92 |
| 3 | | 1.0 | 12.4 | 84.01 |
| 4 | 8% graphite FR | 3.2 | 14.1 | 95.50 |
| 5 | | 1.6 | 13.6 | 91.89 |
| 6 | | 1.0 | 13.5 | 91.44 |
| 7 | 6% graphite FR | 3.2 | 14.0 | 94.82 |
| 8 | | 1.6 | 12.9 | 86.94 |
| 9 | | 1.0 | 11.9 | 90.63 |
| 10 | 4% graphite FR | 3.2 | 14.2 | 96.17 |
| 11 | | 1.6 | 10.6 | 71.85 |
| 12 | | 1.0 | 10.0 | 67.57 |
| 13 | 2% graphite FR | 3.2 | 12.9 | 87.39 |
| 14 | | 1.6 | 8.1 | 54.50 |
| 15 | | 1.0 | 0.7 | 4.50 |
| 16 | 0% graphite FR | 3.2 | 9.0 | 60.81 |
| 17 | | 1.6 | 6.8 | 45.95 |
| 18 | | 1.0 | 1.4 | 9.68 |

The Burn Samples were tested according to the Foam Integrity Test described above. The results and observations are shown in Table 6.

TABLE 6
Foam Integrity Test Results

| All samples were 3.2 mm thick. | | Average of 3 repetitions | | |
|---|---|---|---|---|
| Burn | Graphite FR wt. % and | | Compressive | |
| Sample | Sample Conditioning | Modulus (psi) | Stress (psi) | Load (N) |
| 1 | 10% graphite FR, not burnt | 241.33 | 63.76 | 369.26 |
| 2 | 10% graphite FR, burnt | 72.11 | 27.92 | 50.57 |
| 3 | 8% graphite FR, not burnt | 247.36 | 63.99 | 270.54 |
| 4 | 8% graphite FR, burnt | 99.43 | 31.13 | 58.19 |
| 5 | 6% graphite FR, not burnt | 361.43 | 76.80 | 324.32 |
| 6 | 6% graphite FR, burnt | 71.11 | 23.61 | 99.72 |
| 7 | 4% graphite FR, not burnt | 237.63 | 66.41 | 280.47 |
| 8 | 4% graphite FR, burnt | 90.45 | 28.91 | 122.10 |
| 9 | 2% graphite FR, not burnt | 299.98 | 78.42 | 331.16 |
| 10 | 2% graphite FR, burnt | 0.00 | 0.00 | 0.00 |
| 11 | 0% graphite FR, not burnt | 299.98 | 78.42 | 331.16 |
| 12 | 0% graphite FR, burnt | 0.00 | 0.00 | 0.00 |

The change in the modulus, compressive strength, and load for each of the samples in Table 6 is shown in Table 7, showing the difference in each Burn Sample before and after the Foam Integrity Test was carried out.

TABLE 7
Percent Change After Burn Test of Samples from Table 6

| | | Percent Change | | |
|---|---|---|---|---|
| | Graphite FR | | Compressive | |
| Burn Sample | wt. % | Modulus | Stress | Load |
| 1 | 10% graphite FR | 69.11 | 56.49 | 81.46 |
| 3 | 8% graphite FR | 59.07 | 49.01 | 77.61 |
| 5 | 6% graphite FR | 74.78 | 64.06 | 64.06 |
| 7 | 4% graphite FR | 60.71 | 55.97 | 55.97 |
| 9 | 2% graphite FR | 100.00 | 100.00 | 100.00 |
| 11 | 0% graphite FR | 100.00 | 100.00 | 100.00 |

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

1-15. (canceled)

16. A potting compound comprising:
a polyurethane foam,
wherein the polyurethane foam exhibits at least a V2 level flame resistance as measured by the UL 94 Test for Flammability of Plastics when tested with a portion of the polyurethane foam having a length of no greater than 150 mm, a width of no greater than 13 mm, and a thickness of no greater than one mm, and
wherein a portion of the polyurethane foam having a thickness of no greater than 3.2 mm and having been subjected to the Burn Test exhibits a compressive strength of at least 20 psi when measured with the Foam Integrity Test.

17. The potting compound of claim 16, wherein the polyurethane foam exhibits at least a V1 level flame resistance as measured by the UL 94 Test for Flammability of Plastics when tested with a portion of the polyurethane foam having a length of no greater than 150 mm, a width of no greater than 13 mm, and a thickness of no greater than one mm.

18. The potting compound of claim 16, wherein the polyurethane foam exhibits at least a V0 level flame resistance as measured by the UL 94 Test for Flammability of Plastics when tested with a portion of the polyurethane foam having a length of no greater than 150 mm, a width of no greater than 13 mm, and a thickness of no greater than one mm.

19. The potting compound of claim 16, wherein a portion of the polyurethane foam having a thickness of no greater than 3.2 mm and having been subjected to the Burn Test exhibits a percent change in the modulus of no greater than 80% when measured by the Foam Integrity Test.

20. The potting compound of claim 16, wherein the polyurethane foam includes at least one % by weight a flame retardant component comprising expanded graphite, based on the total weight of the composition.

21. The potting compound of claim 16, wherein the polyurethane foam includes at least two % by weight a flame retardant component comprising expanded graphite, based on the total weight of the composition.

22. The potting compound of claim 16, wherein the polyurethane foam is formed from a composition having a viscosity of no greater than 2000 cp at any time within two minutes after all components of the composition have been combined.

23. A battery module comprising:
an electric cell potted in a potting compound comprising a polyurethane foam,
wherein the polyurethane foam exhibits at least a V1 level flame resistance as measured by the UL 94 Test for Flammability of Plastics when tested with a portion of the polyurethane foam having a length of no greater than 150 mm, a width of no greater than 13 mm, and a thickness of no greater than one mm.

24. The battery module of claim 23 wherein a portion of the polyurethane foam having a thickness of no greater than 3.2 mm and having been subjected to the Burn Test exhibits a percent change in the modulus of no greater than 80% when measured by the Foam Integrity Test.

25. The battery module of claim 23 wherein, with a portion of the polyurethane foam having a length of no greater than 150 mm, a width of no greater than 13 mm, and a thickness of no greater than one mm, at least 60% of the portion of the polyurethane foam remains after the portion of polyurethane foam is subjected to the Foam Core Integrity Test.

26. The battery module of claim 23 wherein a portion of the polyurethane foam subjected to the Burn Test exhibits a compressive strength of at least 20 psi when measured with the Foam Integrity Test using a sample of the polyurethane foam having a thickness of no greater than 3.2 millimeter.

27. The battery module of claim 23 wherein the polyurethane foam exhibits at least a V0 level flame resistance as measured by the UL 94 Test for Flammability of Plastics when tested with a portion of the polyurethane foam having a length of no greater than 150 mm, a width of no greater than 13 mm, and a thickness of no greater than 1.6 mm.

28. The battery module of claim 23 wherein the polyurethane foam exhibits at least a V0 level flame resistance as measured by the UL 94 Test for Flammability of Plastics when tested with a sample of the polyurethane foam having a length of no greater than 150 mm, a width of no greater than 13 mm, and a thickness of no greater than one mm.

29. The battery module of claim 23 wherein the polyurethane foam includes at least one % by weight a flame retardant component comprising expandable graphite, based on the total weight of the composition.

30. A battery module comprising:
an electric cell potted in a potting compound comprising a polyurethane foam,
wherein the polyurethane foam includes at least one % by weight a flame retardant component comprising expandable graphite, based on the total weight of the composition, and
wherein the polyurethane foam exhibits at least a V2 level flame resistance as measured by the UL 94 Test for Flammability of Plastics when tested with a sample of the polyurethane foam having a length of no greater than 150 mm, a width of no greater than 13 mm, and a thickness of no greater than one mm.

31. The battery module of claim 30 wherein the polyurethane foam exhibits at least a V1 level flame resistance as measured by the UL 94 Test for Flammability of Plastics when tested with a sample of the polyurethane foam having a length of no greater than 150 mm, a width of no greater than 13 mm, and a thickness of no greater than one mm.

32. The battery module of claim 30 wherein the polyurethane foam exhibits at least a V0 level flame resistance as measured by the UL 94 Test for Flammability of Plastics when tested with a sample of the polyurethane foam having a length of no greater than 150 mm, a width of no greater than 13 mm, and a thickness of no greater than one mm.

33. The battery module of claim 30 wherein, with a portion of the polyurethane foam having a length of no greater than 150 mm, a width of no greater than 13 mm, and a thickness of no greater than one mm, at least 60% of the portion of the polyurethane foam remains after the portion of polyurethane foam is subjected to the Foam Core Integrity Test.

34. The battery module of claim 30 wherein a portion of the polyurethane foam having a thickness of no greater than 3.2 mm and having been subjected to the Burn Test exhibits a percent change in the modulus of no greater than 80% when measured by the Foam Integrity Test.

35. The battery module of claim 30 wherein the polyurethane foam is formed from a composition that is configured to flow under its own weight and settle at a substantially level height around, and in direct contact with an outer surface of, the electric cell before curing to foam the potting compound.
